(19) United States
(12) Patent Application Publication
(10) Pub. No.: US 2026/0100909 A1
(43) Pub. Date: Apr. 9, 2026

(54) COLLECTIVES-AWARE LOAD BALANCING

(71) Applicant: Oracle International Corporation, Redwood Shores, CA (US)

(72) Inventor: Chetan Loke, Westborough, MA (US)

(73) Assignee: Oracle International Corporation, Redwood Shores, CA (US)

(21) Appl. No.: 19/349,766

(22) Filed: Oct. 3, 2025

Related U.S. Application Data
(60) Provisional application No. 63/703,658, filed on Oct. 4, 2024.

(51) Int. Cl. H04L 47/125; H04L 47/122; H04L 47/62

(52) U.S. Cl. CPC H04L 47/125; H04L 47/122; H04L 47/6235

(57) ABSTRACT

Systems, methods, and machine-readable media may facilitate programmable data trimming. Metadata associated with a collective operation may be determined by an application of a server. The metadata may specify a job identifier corresponding to a unit of work to be completed in conjunction with the collective operation, a collective type of the collective operation, and/or an ordering mode for packets corresponding to the collective operation. The metadata associated with the collective operation may be sent by the application to a network interface card (NIC). The NIC may be caused by the application to transmit a data packet with the metadata embedded in a cookie of the data packet to a switch of a network fabric to cause the switch to use a selected network path and/or selected load-balancing for the collective operation based on one or more of the job identifier, the collective type, and/or the ordering mode.

### CROSS-REFERENCE TO RELATED APPLICATION

The present application claims the benefit of and priority to U.S. Provisional Application No. 63/703658, filed October 4, 2024, the entire contents of which are incorporated by reference herein for all purposes.

### TECHNICAL FIELD

This disclosure generally relates to collectives-based workloads and communications, and particularly to systems, methods, and computer-readable media for collectives-aware load balancing.

### BACKGROUND

Distributed computing systems have evolved significantly over the years, with various paradigms such as the master-server model, batching model, and threading model being widely adopted to manage parallelism and coordination across heterogeneous hardware. However, these paradigms often prioritize scalability and fault tolerance at the expense of strict consistency requirements, particularly in scenarios where all nodes must achieve synchronized progress. In contrast, the collective programming model represents a distinct approach, where all worker nodes within a cluster operate as true peers, requiring strict consistency across the entire group at specific points in time. This model is particularly critical in applications such as artificial intelligence (AI) and machine learning (ML), where distributed training and inference tasks demand synchronized communication among all nodes to ensure correctness and efficiency.

In a collective programming model, progress is contingent upon the successful completion of communication operations involving all nodes. For example, operations such as all-to-all or reduce-scatter require every node to exchange data with every other node or aggregate results globally before proceeding to the next phase of computation. This strict dependency on global synchronization introduces a unique challenge: if any single node lags due to computational bottlenecks, resource contention, or network latency, the entire collective effort is delayed, potentially degrading performance across the entire system. This issue is exacerbated in large-scale clusters, where thousands or even hundreds of thousands of nodes (e.g., GPUs, CPUs, or hybrid XPU architectures) must coordinate simultaneously.

Current solutions for managing communication in such environments often rely on transport-layer mechanisms, such as Equal-Cost Multipath (ECMP) routing or round-robin load balancing, to distribute traffic across network tiers (e.g., leaf and spine switches). However, these approaches lack application-awareness and fail to account for the specific requirements of AI/ML workloads, such as the dynamic demands of training algorithms, the use of Remote Direct Memory Access (RDMA), or the heterogeneous utilization of CPUs and GPUs within a node. For a collectives-based workload and/or communications patterns running on an Ethernet based network, ECMP based or similar load-balancing algorithms do not scale well or in some cases are detrimental to the workloads. As a result, these methods may lead to suboptimal network utilization, increased latency, or contention, particularly in scenarios involving complex collective operations.

Thus, there is a need to solve these problems and provide for collectives-aware load balancing for RDMA networks. These and other needs are addressed by the present disclosure.

### BRIEF SUMMARY

Certain embodiments of the present disclosure relate generally to collectives-based workloads and communications, and particularly to systems, methods, and computer-readable media for collectives-aware load balancing.

In one aspect, a method may include one or a combination of the following. Metadata associated with a collective operation may be determined by an application of a server. The metadata may specify at least one of: a job identifier corresponding to a unit of work to be completed in conjunction with the collective operation; a collective type of the collective operation; and/or an ordering mode for packets corresponding to the collective operation. The metadata associated with the collective operation may be sent by the application to a network interface card (NIC) communicatively coupled to the server. The NIC may be caused by the application to transmit a data packet with the metadata embedded in a cookie of the data packet to a switch of a network fabric to cause the switch to use a selected network path and/or selected load-balancing for the collective operation based at least in part on one or more of the job identifier, the collective type, and/or the ordering mode.

In another aspect, a system may include one or more processing devices and memory communicatively coupled with and readable by the one or more processing devices and having stored therein processor-readable instructions which, when executed by the one or more processing devices, cause the system to perform one or a combination of the following operations. Metadata associated with a collective operation may be determined. The metadata may specify at least one of: a job identifier corresponding to a unit of work to be completed in conjunction with the collective operation; a collective type of the collective operation; and/or an ordering mode for packets corresponding to the collective operation. The metadata associated with the collective operation may be sent to a network interface card (NIC) communicatively coupled to the system. The NIC may be caused to transmit a data packet with the metadata embedded in a cookie of the data packet to a switch of a network fabric to cause the switch to use a selected network path and/or selected load-balancing for the collective operation based at least in part on one or more of the job identifier, the collective type, and/or the ordering mode.

In yet another aspect, one or more non-transitory, machine-readable media having machine-readable instructions thereon which, when executed by one or more processing devices, may cause a system to perform one or a combination of the following operations. Metadata associated with a collective operation may be determined. The metadata may specify at least one of: a job identifier corresponding to a unit of work to be completed in conjunction with the collective operation; a collective type of the collective operation; and/or an ordering mode for packets corresponding to the collective operation. The metadata associated with the collective operation may be sent to a network interface card (NIC) communicatively coupled to the system. The NIC may be caused to transmit a data packet with the metadata embedded in a cookie of the data packet to a switch of a network fabric to cause the switch to use a selected network path and/or selected load-balancing for the collective operation based at least in part on one or more of the job identifier, the collective type, and/or the ordering mode.

In various embodiments, the ordering mode may correspond to an in-order mode, and the packets corresponding to the collective operation, including the data packet, may be sent by the switch in-order on the same link in accordance with the metadata. In various embodiments, the ordering mode may correspond to an out-of-order mode, and the packets corresponding to the collective operation, including the data packet, may be sent by the switch out-of-order across disparate links in accordance with the metadata. In various embodiments, the ordering mode may correspond to a selective out-of-order mode, and a first subset of the packets corresponding to the collective operation are sent in-order on the same link while a second subset of the packets may be sent out-of-order across disparate links in accordance with the metadata.

In various embodiments, the metadata associated with the collective operation may be sent to the switch. In various embodiments, a mapping of the metadata to particular actions may be sent via the NIC to the switch. The switch may use the mapping to interpret the metadata and perform one or more actions corresponding to the use of the selected network path and/or the selected load-balancing for the collective operation. In various embodiments, the switch may be caused to use the selected network path specified by the metadata. In various embodiments, the switch may be caused to use the selected load-balancing for the collective operation to route the unit of work over one or more specified paths. In various embodiments, the selected load-balancing may include routing traffic with a path group in round robin mode over links of the path group.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram illustrating an example architecture in which collectives-aware (CA) load balancing (LB) may be implemented, according to certain embodiments.

FIG. 2 illustrates packet formatting examples with examples of app-hints placement, according to various embodiments.

FIG. 3 illustrates one example method to facilitate collectives-aware load balancing, according to certain embodiments.

FIG. 4 is a high-level diagram of a distributed environment showing a virtual or overlay cloud network hosted by a cloud service provider infrastructure according to certain embodiments.

FIG. 5 depicts a simplified architectural diagram of the physical components in the physical network within CSPI according to certain embodiments.

FIG. 6 shows an example arrangement within CSPI where a host machine is connected to multiple network virtualization devices (NVDs) according to certain embodiments.

FIG. 7 depicts connectivity between a host machine and an NVD for providing I/O virtualization for supporting multitenancy according to certain embodiments.

FIG. 8 depicts a simplified block diagram of a physical network provided by a CSPI according to certain embodiments.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

In a collective programming model, progress is contingent upon the successful completion of communication operations involving all nodes. For example, operations such as all-to-all or reduce-scatter require every node to exchange data with every other node or aggregate results globally before proceeding to the next phase of computation. This strict dependency on global synchronization introduces a unique challenge: if any single node lags due to computational bottlenecks, resource contention, or network latency, the entire collective effort is delayed, potentially degrading performance across the entire system. This issue is exacerbated in large-scale clusters, where thousands or even hundreds of thousands of nodes (e.g., GPUs, CPUs, or hybrid XPU architectures) must coordinate simultaneously.

Current solutions for managing communication in such environments often rely on transport-layer mechanisms, such as Equal-Cost Multipath (ECMP) routing or round-robin load balancing, to distribute traffic across network tiers (e.g., leaf and spine switches). However, these approaches lack application-awareness and fail to account for the specific requirements of AI/ML workloads, such as the dynamic demands of training algorithms, the use of Remote Direct Memory Access (RDMA), or the heterogeneous utilization of CPUs and GPUs within a node. As a result, these methods may lead to suboptimal network utilization, increased latency, or contention, particularly in scenarios involving complex collective operations.

Compounding these challenges, modern AI/ML training frameworks often leverage Collective Communications Libraries (CCL), which abstract low-level communication details and enable efficient implementation of collective operations (e.g., all-reduce, broadcast) using Message Passing Interface (MPI) protocols. However, as cluster sizes grow to tens of thousands or even hundreds of thousands of nodes or more, the interactions between these libraries, the underlying hardware, and the network infrastructure become increasingly complex. For instance, in large-scale clusters, customers may sub-partition a shared cluster into multiple logical partitions (e.g., Partition A and Partition B), which may span non-physically co-located servers. This configuration may introduce cross-traffic and noisy neighbor effects, where communication within a partition inadvertently impacts other partitions, leading to unpredictable performance degradation and resource contention.

Furthermore, the heterogeneity of modern computing nodes—equipped with CPUs, GPUs, and specialized XPUs—adds another layer of complexity. Training workloads may dynamically offload tasks between these components (e.g., pre-training on CPUs and fine-tuning on GPUs), requiring seamless coordination between hardware tiers. At scale, managing such interactions while maintaining strict consistency and minimizing cross-partition noise becomes a critical technical challenge.

The limitations of existing approaches in addressing these issues underscore a pressing need for an innovative solution that optimizes collective communication in large-scale AI/ML workloads. Specifically, there is a need for a system according to embodiments according to the present disclosure that: enables application-aware load balancing and traffic management across heterogeneous hardware and network tiers, tailored to the dynamic demands of AI/ML workloads; ensures strict consistency and synchronization across all nodes in a collective, even in the presence of heterogeneous XPU utilization and varying computational workloads; and mitigates cross-partition noise and resource contention in multi-tenant environments, where clusters are subdivided into logical partitions with complex communication patterns. Disclosed embodiments according to the present disclosure provide a solution to all the above-described challenges with a novel framework for managing collective communication in large-scale distributed systems, particularly in the context of AI/ML training.

Disclosed embodiments may provide for a multi-part process that may include: building and providing a required infrastructure or hints (herein referred to either as hints or LB-metadata or LB-hints or app-hints) to a LB (load balancing) algorithm; and a collective-aware LB algorithm (herein referred to as CA-LB) that may use such hints to process collectives traffic in an efficient and performant manner. Moreover, disclosed embodiments may address critical limitations in current load-balancing algorithms for AI/ML workloads on multi-tier RoCE networks, where even the most efficient implementations fall short of the performance achievable with Infiniband (IB) networks. Existing LB mechanisms often exhibit uneven link utilization and fail to adapt to dynamic network events such as link flaps, link failures, or topology changes. These shortcomings are exacerbated by the inability of current algorithms to explicitly recognize application-specific collectives, forcing switches to rely on probabilistic sampling of metadata (e.g., IP addresses, QP IDs) to infer collective types. This approach is inherently non-deterministic and prone to failure when network configurations evolve (e.g., shifts from rail-optimized Clos topologies to fat-tree or multi-planar architectures). Furthermore, switches lack the capability to prioritize jobs or identify which collectives belong to the same workload, as all RDMA traffic is typically aggregated into a single traffic class in current implementations (e.g., OCI’s RDMA clusters). This limitation becomes particularly problematic as AI/ML workloads increasingly adopt novel collective patterns, necessitating manual modifications to existing mechanisms.

By enabling users/applications to explicitly pass application-specific hints to the network, the disclosed embodiments may empower switches to make deterministic, workload-aware decisions. This approach may eliminates the need for probabilistic sampling and allow switches to leverage their core capabilities—switching, routing, and LB—while aligning with the unique requirements of AI/ML applications. For instance, hints can encode information about collective types, job priorities, or preferred path groups, enabling switches to dynamically optimize traffic distribution, prioritize critical workloads, and avoid reordering or congestion without requiring changes to network infrastructure or application code. This may programmability ensure robustness in dynamic environments and unlock performance gains that are unachievable with current, passive LB strategies.

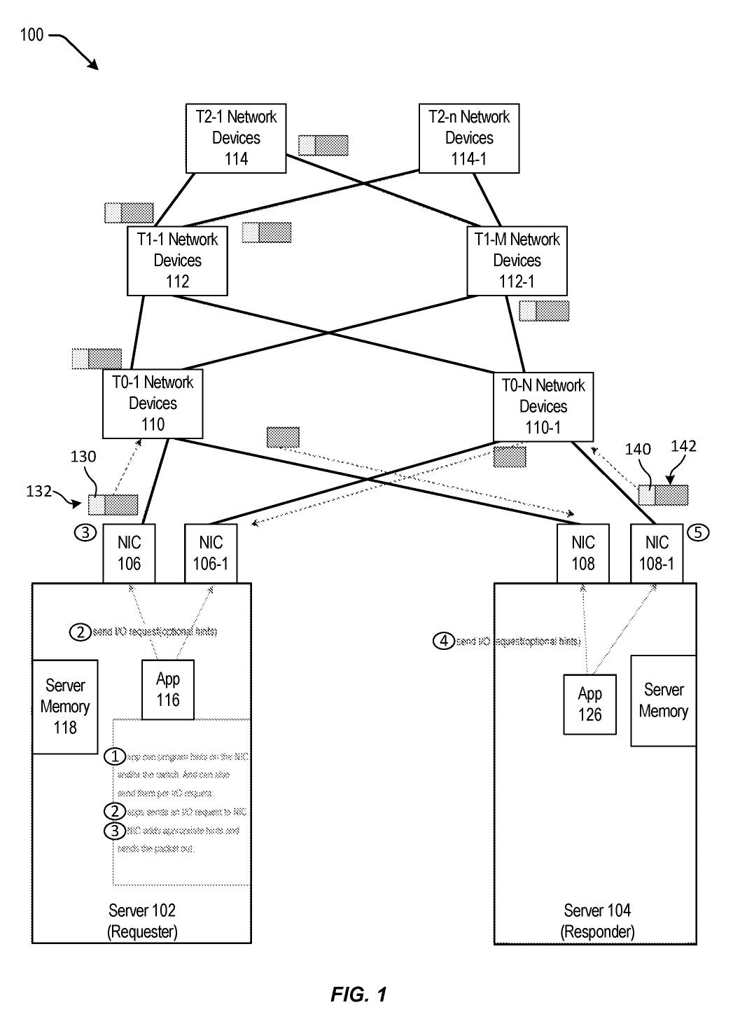

Various embodiments will now be discussed in greater detail with reference to the accompanying figures, beginning with FIG. 1.

FIG. 1 is a block diagram 100 illustrating an example architecture in which collectives-aware (CA) load balancing (LB) may be implemented, according to at least one embodiment. In some examples, the architecture may be configured for high performance computing (HPC) and artificial intelligence (AI) model training using collectives. The architecture may include at least two endpoints corresponding to computational servers (worker nodes): a server 102 corresponding to a requester (that may also be referenced herein as “requester server 102”) and a server 104 corresponding to a responder (that may also be referenced herein as “responder server 104”). While only two servers are shown as a simplified example, the architecture may include many more servers on the order of 10s, hundreds, thousands, hundreds of thousands, or more.

In the context of CA-LB and high-performance computing environments, a job may refer to a specific unit of work, such as a task, process, or application, with defined resource requirements and execution parameters (e.g., a single simulation process in an HPC cluster). A collective may denote a group of coordinated jobs or processes that must communicate or synchronize to achieve a shared objective (e.g., a parallel job with multiple MPI processes in a distributed simulation). A workload may encompass the aggregate of all jobs, collectives, and processes running across a system or cluster, representing the overall computational demand and resource utilization (e.g., a mixed workload in a cloud environment including batch jobs, real-time applications, and interactive tasks).

In various embodiments, the requester server 102 may correspond to a host machine, such a physical, bare metal server, or a virtual server or other cloud-based server. The requester server may include or be otherwise coupled to one or more NICs, such as NIC 106 and NIC 106-1, that enable the host machine to be connected to other devices. Although two NICs are shown as an example, the server 102 may include any suitable number of NICs. The responder server 104 may also be a host machine, such a physical, bare metal server, or a virtual server or other cloud-based server. The server 104 may include one or more NICs such as NIC 108 and NIC 108-1 that enable the server 104 to be connected to the physical network and the network devices. Although two NICs are shown as an example, the server 104 may include any suitable number of NICs, which may, for example, correspond to RDMA NICs and/or VNICs.

In various embodiments, the NICs may, for example, correspond to RDMA (remote direct memory access) NIC, VNICs (virtual NICs), and/or smartNICs. In some embodiments, the VNICs may be configured as RDMA NICs. RDMA enables network devices to move data directly between the memory of two computers, eliminating the need for the operating system and CPU in high-performance computing environments. This direct memory access reduces latency, boosts data transfer rates, and minimizes CPU usage, making it particularly well-suited for applications such as AI, big data analytics, and high-performance storage systems. An RDMA NIC is a specialized network adapter that enables RDMA, facilitating direct data transfer between the memory of two computers while bypassing their CPUs. This zero-copy mechanism substantially reduces latency, enhances throughput, and offloads processing demands from the CPU, making it a critical component for high-performance applications such as high-performance computing and complex database systems. The NIC 106 and NIC 106-1 may provide one or more ports (or interfaces) that enable the server 102 to be communicatively connected to one or more other devices.

For example, the server 102 may be connected to a physical network that provides a communication fabric. The physical network may be a multi-tiered network. The illustrated example depicts a 3-tier network with network devices at different tiers, viz., network devices 110, 110-1, 112, 112-1, 114, and 114-1. Additional examples with respect to a multi-tiered network are disclosed further herein. Different network configurations are possible. Each of the nodes corresponding to the network devices 110, 110-1, 112, 112-1, 114, and 114-1 may include one or more switches and may have a plurality of devices (e.g., servers) communicatively coupled to it. For example, the T0-1 and T0-N network devices 110, 110-1 may correspond to leaf switches for ingress and egress and may be communicatively coupled to a plurality of servers (e.g., two, eight, fifty, or more). Servers and endpoints may connect directly to the tier 0 switches. The tier 0 switches may aggregate traffic from all the servers, storage, other endpoints, and switches connected to them. The T1-1 and T1-M network devices 112, 112-1 may, for example, correspond to spine switches that may be communicatively coupled to the other switches to connect all of them together with high-speed connectivity. The T2-1 and T2-n network devices 114, 114-1 may, for example, correspond to super-spine switches that may be communicatively coupled to the spine switches to connect the spine switches together for greater scalability. The tier 2 switches may aggregate traffic from the lower layer with high-speed connectivity. It should be understood that the depicted illustration is merely a simplified example of what could be extended to much greater scale and complexity.

When a cluster is handed over to a customer, they may further sub-partition existing partitions (e.g., partition A or partition B) into smaller sub-clusters (e.g., sub-cluster A or sub-cluster B). Applications running on these sub-partitions may be identical in nature (e.g., both executing a ChatGPT model) but require the network to distinguish between their respective traffic flows. For example, a platinum-tier partition (e.g., a high-priority training workload) and a bronze-tier partition (e.g., a lower-priority workload) may be isolated to ensure the platinum-tier workload receives preferential treatment, such as 70% of switch resources compared to the bronze-tier workload. This differentiation is critical to maintaining quality of service (QoS) guarantees and preventing resource contention between co-located partitions.

Disclosed embodiments may address this challenge by enabling the network to prioritize traffic based on tiered classifications (e.g., platinum, bronze) and workload-specific requirements. For instance, a platinum-tier partition may require a higher allocation of switch resources (e.g., 70% of available bandwidth) compared to a bronze-tier partition, even if both partitions execute identical applications. This may ensure that high-priority workloads complete training tasks efficiently while lower-priority workloads are dynamically throttled or rerouted based on available capacity. The network leverages app-hints to enforce these prioritization rules, ensuring that traffic from different partitions is handled according to their assigned tier and resource allocation targets.

To facilitate isolation between partitions and address other challenges disclosed herein, disclosed embodiments may embed metadata with app-hints, for example, as cookies. These cookies may be processed by network endpoints, switches, and NICs to associate traffic flows with specific partitions (e.g., partition A or partition B). For example, a flow originating from sub-cluster A may be tagged with a unique identifier, enabling switches to route or isolate it from flows in sub-cluster B. This tagging mechanism may ensure that traffic from different partitions remains logically separated, even when sharing the same physical network infrastructure. The cookies may also allow network devices to apply tailored policies, such as bandwidth allocation, latency guarantees, or congestion control, based on the partition’s tier and workload requirements.

In accordance with various embodiments, an application (e.g., application 116 of the server 102 and/or application 126 of the server 104) and/or a user may provide/program hints, which can then be parsed by a capable device (hardware and/or software) and provide application-aware functionalities such as collective-aware LB (load-balancing), advanced congestion control, collectives grouping, and collectives level QoS (quality of service). These application hints (herein referenced as app-hints or CA-app-hints) may be tagged as LB-hints, congestion-control (CC) hints (CC-hints), QoS hints, and/or the like. In various embodiments, app-hints may or may not be self-contained. In embodiments where the app-hints are not self-contained, an external application (e.g., application 116 and/or application 126) may program the switch’s control-plane and/or the switch and provide further instructions on processing the hints.

The cookies may, for example, facilitate the network further optimizing traffic based on the type of collective operation being executed (e.g., all-reduce, all-to-all). By analyzing the characteristics of the collective (e.g., communication patterns, data volume, and latency sensitivity) specified by the cookies, the network can dynamically adjust routing strategies, load-balancing algorithms, and resource allocation. For instance, a collective that generates high fabric utilization (e.g., a custom all-to-all operation) may be prioritized for dedicated paths or congestion-aware routing, while a less-intensive collective (e.g., a standard all-reduce) may be interleaved with other traffic. This collective-specific optimization may ensure that the network adapts to the unique demands of each workload, maximizing throughput and minimizing contention.

In some examples, app-hints may be enabled, and the switches and/or worker nodes may perform appropriate actions based on the app-hints. In some instances, app-hints may be incomplete and may require one or both of fetching additional metadata and forwarding some decision-making and/or processing to an external agent (hardware and/or software). In some no-op instances, app-hints may be ignored, and stock/current/default algorithm currently configured on the devices may be applied. Other examples are possible.

The switches may be configured with a predefined mapping of app-hints to specific actions, enabling the switches to interpret the embedded metadata and execute deterministic routing, load-balancing, or resource-allocation decisions. This mapping may be implemented as part of the switch’s firmware or hardware logic, ensuring that all endpoints—such as NICs and switches—understand the header format and its associated semantics. To maintain consistency across the network, the specification for the header format and its corresponding actions may be provided as a specific implementation configuration, ensuring that all devices, once programmed, uniformly recognize and act on the hints. This standardized approach may eliminate ambiguity, as a switch’s behavior is strictly defined by the header’s content, allowing for seamless coordination between endpoints without requiring dynamic negotiation or per-device customization.

As detailed herein, the actions that switches in the network fabric may take based on interpreting metadata (app-hints) embedded in data packets to dynamically adapt network may include, but are not limited to, one or a combination of: selecting an optimal network path based on the collective type (e.g., broadcast, reduction) and ordering mode (in-order or out-of-order delivery), applying load-balancing algorithms such as Random Path Group (RPG), Round-Robin Path Group (RRPG), or custom algorithms defined by the job identifier or collective type, enforcing ordering constraints to ensure packets are transmitted in a sequence compliant with the metadata, prioritizing traffic based on job identifiers or collective types, implementing congestion control or quality-of-service (QoS) policies tailored to the workload, routing packets to specific destinations within the fabric, and optimizing for collective operations to reduce latency or improve synchronization. These capabilities enable switches to dynamically adapt to application-specific requirements, ensuring efficient, fair, and context-aware resource allocation in distributed computing environments.

Versioning and/or compatibility checks and negotiation may happen in-band or out-of-band. App-hints-aware devices may respond in an implementation-specific manner to notify the participants such as NICs, peer switches or any devices in the transit, of a version mismatch. An external application (e.g., application 116 and/or application 126) may also query all the concerned devices a priori and ensure all the participated devices have the requisite versioning support and enable/program the devices to the specific version as required.

In some examples of PMTU (path MTU) and general compliancy plus compatibility, the application and/or a user may configure app-hints that add an extra-header to avoid any violations/breakage as the app-hints flow through the network and pass through one or more CA-app-hints-unaware devices. For example, the app-hints may be configured to avoid breakage of PMTU rules, alignment, and non-overflow and to avoid protocol violations such that they do not create fatal errors anywhere in the network. The app-hints in general (irrespective of app-hints placement) may be configured to not violate or cause fatal errors as they flow through non-CA-app-hints-aware devices.

In scenarios where not all NICs support custom headers or app-hints, seamless interoperability may be ensured by the header formatting including instructions for leaf switches to selectively process or discard these custom headers based on the destination of the packet. For example, if a packet is destined for a host, the leaf switch may be programmed to strip the custom headers before forwarding the packet to the host, preventing unsupported NICs from misinterpreting or rejecting the traffic. Conversely, if the destination is another fabric device (e.g., a switch or router), the headers may be retained to allow further processing by downstream devices. This capability introduces a high degree of programmability, enabling the system to dynamically adapt to heterogeneous network environments while maintaining compatibility with legacy or non-supporting hardware. By embedding these conditional instructions within the headers, the network may ensure efficient traffic handling, minimize disruptions, and preserve the flexibility to tailor header processing based on device capabilities and workload requirements.

In an example flow of how app-hints may influence switch behavior and traffic routing, say the server 102 may run job X, and the server 104 may run job Y. Say job X runs a collective for which the data can be distributed in any manner, so the application 116 may instruct the hint into the NIC 106 specifying that the package may be sprayed in any manner. Job Y, on the other hand, may run a collective for which the data packets need to be delivered in order, not OOO. As indicated at operation 1, the application 116 of the requester server 102 may program app-hints on the NIC (e.g., NIC 106 and/or NIC 106-1) and/or one or more switches (e.g., network devices 110, 110-1, 112, 112-1, 114, and 114-1). In some examples, in addition or in alternative, the application 116 may send the app-hints per I/O request. As indicated at operation 2, the application 116 may send an I/O request to one or more NICs (e.g., NIC 106 and/or NIC 106-1). In various examples, the I/O request may or may not include the app-hints. As indicated at operation 3, the NIC (say, for example, NIC 106) may add the app-hints to the packet (e.g., by adding cookie 130 to the packet 132) and transmit the packet to the fabric (e.g., to the T0-1 network device(s) 110). Say, the embedded app-hint signals whether the receiving endpoint can tolerate out-of-order (OOO) delivery. While only one packet is illustrated, say the NIC 106 sends five packets corresponding to job X to the T0-1 network device 110 and all five packets indicate OOO delivery. The switch (device 110) may send one packet on one link, another packet on another link, and spray all the packets across five links. Thus, as all five packets from NIC 106 indicate OOO tolerance, the T0-1 network device 110 distributes them across multiple links, spraying traffic to balance load and accelerating delivery. This parallel transmission ensures packets arrive independently on the receiver side (e.g., server 104), eliminating delays caused by sequential dependencies, as the receiver is not waiting on any particular packet to arrive.

The application 126 of server 104 may perform similar operations and, for example, may send an IO request to NIC 108-1, as indicated by operation 4. However, say the NIC 108-1 receives an app-hint from application 126 specifying strict in-order delivery. As indicated at operation 5, the NIC 108-1 may embed this app-hint instruction in cookie headers of its packets (e.g., by adding cookie 140 to the packet 142), which the NIC 108-1 sends to the fabric by way of a switch (e.g., T0-N network device 110-1). The T0-N network device 110-1 may interpret this app-hint and enforce sequential transmission, routing all the packets (e.g., five packets corresponding to job Y) over a single link in their original order, avoiding any out of order reception on the receive side. While this guarantees in-order arrival, it may increase latency due to serialized processing. Any packet loss or reordering during transmission could force the receiving NIC to wait for missing packets, further delaying completion. For workloads like job X, which can tolerate OOO delivery, this approach may minimize latency and improve fault tolerance, as the receiving NIC can reassemble packets or store them directly in memory regardless of arrival order. In contrast, workloads like job Y, which rely on strict in-order delivery, may face higher latency in error-prone networks due to retransmissions or reordering caused by link failures, buffer overflows, or other fabric issues.

The flexibility of app-hints may extend to programmatically defining path groups, specifying path groups or enabling endpoints (e.g., tier-0, tier-1, or tier-2 switches, or NICs) to dynamically select subsets of available links (e.g., using N out of M uplinks from T0 to T1). This eliminates hardcoded configurations, allowing switches to adapt to workload-specific requirements. For instance, if an application cannot tolerate OOO delivery, the switch may pin traffic to a single link or prioritize specific paths, ensuring deterministic behavior while maintaining scalability. This may programmability ensure the network infrastructure aligns with application needs, optimizing performance without requiring manual intervention.

The NICs and switches may be programmed or configured using a combination of firmware, driver software, and network policy frameworks to enable the described operations. For the NIC, metadata embedding may be implemented through firmware or driver-level code that intercepts outgoing data packets and injects application-specific metadata (e.g., job identifiers, collective types, ordering modes) as a structured cookie within the packet header. This configuration may be managed via a configuration interface (e.g., a management console, API, or scripting tool) that allows administrators to define metadata formats, injection rules, and compatibility with specific applications or workloads. For example, the application 116 or 126 may communicate metadata to one or more of the NICs through a standardized protocol (e.g., a custom API or RDMA-based interface), enabling the one or more NICs to dynamically embed the metadata.

One or more of the switches may be configured with a rule engine or policy table that maps metadata values (e.g., job identifiers, collective types, ordering modes) to specific network actions (e.g., routing paths, load-balancing strategies, traffic prioritization). This configuration may be achieved through a centralized control plane (e.g., a software-defined networking (SDN) controller, a configuration file, or a web-based interface) that allows network administrators to define mappings between metadata and switch behaviors. For instance, a switch may be programmed to prioritize in-order mode for latency-sensitive tasks (e.g., AI/ML synchronization operations) or apply round-robin load-balancing within a path group for bulk data transfers. In some embodiments, the switch may use programmable logic (e.g., P4-based hardware) to dynamically interpret cookies and execute routing decisions in real time, ensuring alignment with application-defined policies. This configuration may ensure that the network infrastructure adapts autonomously to application needs, enabling efficient communication in distributed systems such as AI/ML training clusters.

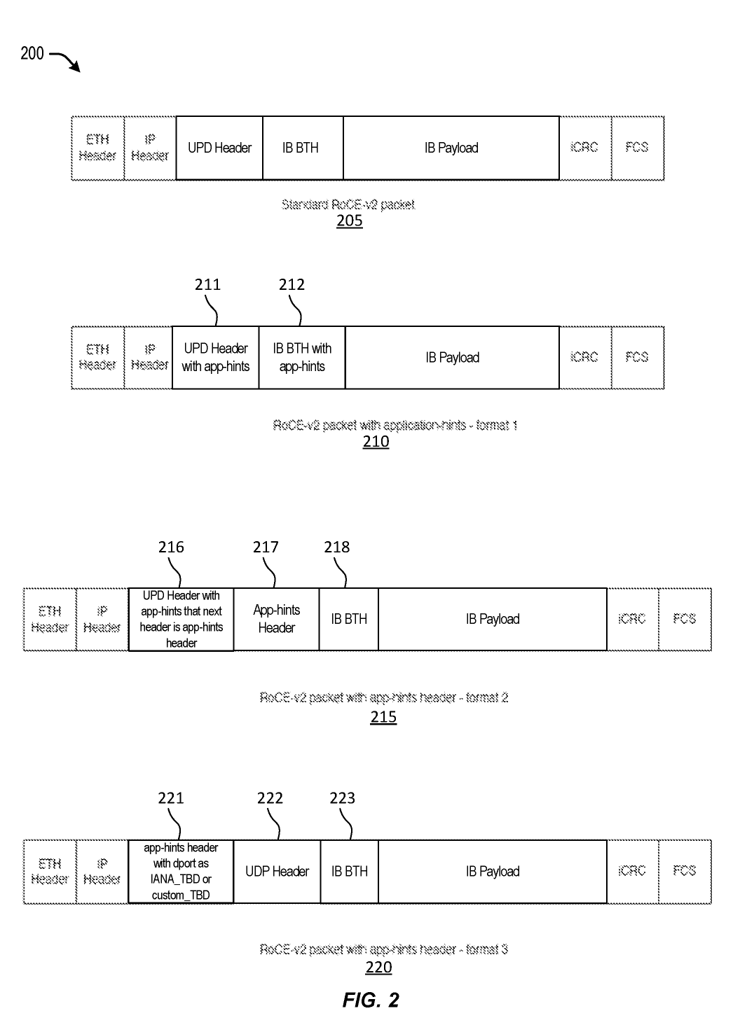

FIG. 2 illustrates packet formatting examples 200 with examples of app-hints placement, according to various embodiments. App-hints placement may be done in various ways. Some examples may preserve existing wire format. The app-hints that may be added to packet headers (e.g., with tags). The app-hints may be placed in unused/reserved fields in any of the protocol headers of packets. Some examples may extend existing wire format. The app-hints may be placed in a way that is silicon and/or parsing friendly from the network devices’ point of view. Depending on app-hints placement, app-hints unaware devices may work as-is without breaking the following (and not limited to): performance, functionality, and security. In some embodiments, users may also select app-hints placement in a way that is backwards-compatible with their network, compute and/or I/O devices.

The formatting of packet headers for app-hints may be highly flexible, depending on the level of functionality and programmability implemented. App-hints may be embedded in various locations within the header structure, such as preceding specific headers, integrated into UDP headers, or distributed across multiple header segments. For example, app-hints may be placed inline in the InfiniBand (IB) Base Transport Header (BTH) and/or UDP source-port field or may be placed in an INT (Inband Network Telemetry) or INT-like header. To ensure switches and network interface cards (NICs) can consistently identify and process these hints, a universal tagging mechanism may be implemented. This may involve reserving designated bits within space of the header to serve as a universal indicator, analogous to how Ethernet, RoCE, or other packet types are classified. By embedding this tagging mechanism, network devices may be explicitly informed of the presence and location of app-hints, enabling them to parse traffic accurately and apply tailored operations. Once recognized, the switches and fabric hops may dynamically interpret the hints to optimize load balancing, isolate flows between partitions (e.g., pinning partition A’s traffic to specific paths while separating it from partition B’s traffic), and implement any custom policies or service provider-specific configurations programmed into the app-hints header. This approach may ensure seamless interoperability across heterogeneous network components while maintaining the flexibility to adapt to diverse workload requirements.

By way of example, the packet formatting examples 200 are provided. Packet 205 illustrates a standard RoCE-v2 packet for comparison. As illustrated, the packet 205 may include an ethernet header, an IP header, a UDP header, an IB BTH, an IB payload, an iCRC (invariant cyclic redundancy check), and an FCS (frame check sequence). Packet 210 illustrates a RoCE-v2 packet with app-hints according to a first example format. In the first example of packet 210, app-hints may be embedded in a UDP header 211 and/or an IB BTH 212. Packet 215 illustrates a RoCE-v2 packet with an app-hints header according to a second example format. In the second example of packet 215, a UDP header 216 may be embedded with app-hints that indicate that the next header is an app-hints header, and a distinct app-hints header 217 may follow. Thus, the app-hints header 217 may be placed between the UDP header 216 and an IB BTH 218. Packet 220 illustrates a RoCE-v2 packet with an app-hints header according to a third example format. In the third example of packet 220, an app-hints header 221 may include an IANA-specified or custom-specified dport (destination port) before a UDP header 222 and an IB BTH 223.

The app-hints that may be added to packet headers may specify one or a combination of the following. The app-hints may specify app-hint operation types: no-op, operate-and-strip (and its variants), operate-and-ship (and its variants), no-op-and-ship, and/or the like. The app-hints may specify LB modes that may include one or a combination of: Random, Random Path Group, Round Robin, RRPathGroup (Round Robin Path Group), implementation defined, least congested, etc. The app-hints may specify packet order mode, such as in-order, pure out-of-order (OOO) (per-packet), or selective OOO. Thus, for example, the app-hints may facilitate managing packet ordering. In some scenarios, nodes can tolerate out-of-order (OOO) packet delivery, allowing switches to randomly distribute packets across the network to maximize throughput. However, certain collectives or nodes may require strict ordering to maintain correctness. Without explicit app-hints, switches cannot determine which partitions of the network support OOO delivery, leading to suboptimal or static partitioning configurations that are undesirable in dynamic environments. Partition-specific hints embedded into the metadata may inform switches whether OOO delivery is permissible in a given network partition, enabling real-time, fine-grained control over traffic management without requiring manual reconfiguration of switch hardware. The use of real-time, app-hints may eliminate the need for static partitioning, enhancing flexibility and scalability.

The app-hints may specify: Collectives Type: “collective algorithm”; this packet belongs to X; sample collective: all-to-all (A2A), all-reduce (AR), CustomCollectiveTyp1, ReduceScatter (RS), and so on. Thus, for example, the app-hints may facilitate a communication framework that supports various collective algorithms, including but not limited to all-to-all, all-reduce, and reduce-scatter. These algorithms define distributed communication patterns essential for parallel computing tasks. In an all-to-all operation, each node in a network of N nodes exchanges data with every other node, resulting in N−1 data transfers per node. This process may ensure full data dissemination across the network. In contrast, an all-reduce operation may involve aggregating data across nodes (e.g., via summation, multiplication, or other user-defined operations) and distributing the result. The final aggregated data may be shared with all nodes or retained exclusively by a designated root node, depending on the configuration. The performance of these collectives may be highly dependent on network resource allocation. For instance, all-to-all operations may generate a high volume of concurrent data flows, which can strain network bandwidth and silicon resources. Without explicit guidance, switches may struggle to optimize routing for such operations, potentially leading to inconsistent performance or imbalanced bandwidth allocation. To address this, the CA-app-hints may specify the type of collective operation being executed. The app-hints may enable switches to apply tailored routing strategies, ensuring deterministic and consistent performance during collective operations. For example, app-hints may instruct switches to prioritize specific traffic patterns, avoid congestion, or allocate resources dynamically based on the collective’s characteristics.

The app-hints may specify tuple-pick type, such as UDF (user defined fields); 5-tuple: L4 (sip, dip, sport, RDMA_QueuePairNumber, RDMA_PKey); or using RETH (RDMA Extended Transport Header). The app-hints may specify one or more path groups (PGs): hints that specify which egress paths the CA-LB algorithm must include or exclude in the decision-making and if these PGs are exclusive or shared. The app-hints may specify traffic shift/unshift: When available links fall below a certain threshold, the CA-LB algorithm may be free to shift the traffic to other path groups, marked as shared, and unshift to the original PG when the links come back to the configured threshold.

The app-hints may specify strip-or-ship LB-hints, where there may be variants such as operate-and-strip; operate-and-strip-prior-to-host-egress (in this mode, all network devices in the transit may operate on the hints and only the last network-device forwarding the traffic to the host strips the required headers); or operate-and-strip-TTL, where certain devices may implement a TTL-like counter to control number-of-hops that can view the hints. A device, when encountering a non-zero TTL, may decrement and if the result is zero, the device may strip the required headers. If the final action is to strip, the CA-LB may either strip (its an additional header and perform all the required processing – recalculating all the required checksums is one such processing) or simply reset to ‘0’, ‘1’ or some bit pattern that will not trigger any LB (load balancing, either CA-LB or otherwise) or protocol violations (if any) further down in the transit. If the final action is to ship, CA-LB may leave the LB-hints unchanged. With respect to operate-and-ship, in this mode, all network-devices in the transit may operate on the hints and leave them unchanged. The destination host and/or its peripheral device, such as a NIC/HBA/rNIC/HCA/TCA/IO-controller, may strip the hints or optionally send it to an application for further introspection.

The app-hints may specify namespace-id, which may be used to describe the collectives, applications, devices, and hosts belonging to a group. The app-hints may specify the identity of the collective that the packet belongs to or that is the source of that packet. An app-hint may specify to which tenancy the packet belongs to, for example, enable discerning if its traffic coming from, say, job X or job Y—a job ID. There could be multiple jobs running in the network, and it may be desirable to treat platinum, gold, silver, and bronze tiers of users’ jobs differently based on job IDs mapped to tier ratings.

The specification of a job ID with app-hints may ensure equitable and efficient resource allocation in distributed systems, particularly when multiple collectives or workloads share the same network infrastructure. Without a job ID, the network device (e.g., NIC or switch) may lack the necessary context to differentiate between flows originating from distinct jobs. For example, if two collectives—say, job X and job Y—are executed sequentially, job X might consume a disproportionate amount of silicon resources (e.g., bandwidth, processing capacity) due to its intensive communication patterns. When job Y begins shortly thereafter, the network device may dynamically adjust resource allocation to prevent job Y from being starved of resources, even if it starts after job X has already initiated its data transfers. This may require the device to identify which flows belong to job X and which belong to job Y, enabling it to apply pre-programmed fairness policies (e.g., job X receives 70% of resources, job Y receives 30%).

However, relying solely on job IDs may introduce challenges in environments with shared tenancy partitions. For instance, a single customer might divide their network into multiple partitions (e.g., partition A and partition B), each hosting different jobs. Within a single partition, two users (e.g., user A and user B) might run jobs with identical job IDs (e.g., job X), but these jobs could belong to different sub-tenancies or teams. Without additional classification, the network device cannot distinguish between job X in partition A (associated with user A) and job X in partition B (associated with user B). This ambiguity may undermine fairness mechanisms, as the device cannot enforce resource allocation rules specific to the sub-tenancy or team.

To address this, a tenancy ID in the app-hints may be used as a hierarchical classifier, complementing the job ID. The tenancy ID may allow the network device to identify the broader context (e.g., customer, team, or business unit) to which a job belongs. This may ensure that resource allocation policies are applied not only at the job level but also across tenancy partitions. For example, if job X exists in both partition A and partition B, the tenancy ID may enable the device to differentiate between the two instances, ensuring that fairness rules (e.g., job X in partition A receives 70% of resources, job X in partition B receives 30%) are enforced correctly. By combining job IDs and tenancy IDs, the system may achieve granular control over resource allocation, preventing starvation at both the job and tenancy levels while maintaining fairness across sub-tenancies and shared environments. This dual-layer classification (job ID + tenancy ID) may be advantageous for scenarios where jobs may overlap in identifiers but require distinct treatment based on their tenancy, ensuring that the network infrastructure dynamically adapts to the needs of multiple users, teams, or business units operating within the same or different partitions.

With respect to CA-LB hints packet ordering modes, only novel modes are described here. Implementations for other modes exist today (either out in the open or in closed form) and are provided by network vendors to pick from, and so such modes are added in the modes description for the sake of completeness. Disclosed embodiments may facilitate selective OOO. Within a RDMA flow, the following rules may govern. First, intra-transaction load-balancing: packets belonging to a multi-packet RDMA transaction may be sent in order and on the same link—i.e., in a multi-packet transaction consisting of 4 packets (P1, P2, P3, P4), once an egress link (say, Link ‘Lx’) is identified for routing the 1st packet P1, the remainder of the peer-packets (P2, P3 and P4) may be sent in order and on that same link ‘Lx’. Second, inter-transaction load-balancing: inter-transaction packets belonging to the same RDMA flow may be sent OOO and across disparate links. However, packets belonging to a transaction (i.e., intra-transaction packets) may follow the first rule above. For example, say there are two multi-packet RDMA transactions, T1 and T2. T1 may have packets P1, P2, P3, P4; and T2 may have packets PK1, PK2, PK3, PK4. T1 and T2 may be sent on disparate links. Say link ‘Lx’ is chosen for T1, and link ‘Ly’ is chosen for T2. In this case, packets P1 to P4 may be sent in order on Lx, and PK1 to PK4 may be sent in-order on Ly. In some implementations, packets from T1 and T2 may be inter-leaved on the same link Lx as follows: P1, PK1, P2, PK2, P3, PK3, P4, PK4. However, this interleaving may still follow the first rule above for intra-transaction in-orderness. It is to be noted how packets P1, P2, P3 and P4 may still be sent in order even if there is interleaving with packets from other transaction T2.

In various modes, LB-hints programming may be per-packet, one-time, per-flow, or per-flow-group. In per-packet mode, if the LB-hints are self-contained, CA-LB aware devices, may maintain zero or very minimal state per-flow. There may be multiple ways to program/initialize the hints. An application (e.g., 116 or 126) may program the NIC via pre-defined APIs or pass the hints via APIs such as the IB verbs layer. These hints may be passed on a per I/O basis or for the entire lifetime of the flow. The NIC, upon receiving such hints and depending on the ‘LB-hints placement’ configuration, may program the LB-hints appropriately on an every single outgoing (first time or a retransmitted) packet. LB-hints programming by the NIC may also include calculating all the required checksums. In one-time mode, app-hints programming may happen via any of the programming mechanisms defined above in the per-packet mode. However, there may be certain hints such as ‘Collective Type’ that may change on some frequency, and the application may only refresh those variant or dynamic sub-hints while the rest of the hints stay static.

The collective aware (CA-LB) algorithm may be programmed to skip/bypass any inline (offline, offloaded) processing of LB-hints. Similarly, LB-hints may be enabled but the LB-hints may signal a no-op (no operation), in which case, the CA-LB may either decide the best course of action or simply forward based on any LB policy configured/programmed by the user. In either case, user may configure/program the no-op action. Consider the case where, LB-hints processing is enabled and it is not no-op or no- op-and-ship. In this scenario, the CA-LB may process (inline, offline, offloaded-parsing) the packet and look for LB-hints. Eventual processing may be dependent on the various LB-hints.

With respect to the CA-LB algorithm modes and their workings in the RandomPathGroup algorithm mode, by using path-groups LB-hints, certain collectives (or jobs) may route over M paths, other jobs may route over N paths, and any job(s) may route over left over paths or shared paths. Further, they may also comply with the traffic shift/unshift LB-hint. Traffic within the PG may be routed in random mode and comply with ordering-modes: in-order, OOO or selective-OOO. With respect to the CA-LB algorithm modes and their workings in the RRPathGroup algorithm mode, RoundRobinPathGroup may be similar to RandomPathGroup, however, traffic within a PG may be sent in RR mode over its PG’s links. The algorithm may comply with ordering-modes: in-order, OOO, or selective-OOO. It may be noted that in-order may not be in RR mode at a packet boundary. Discretion may be left to the device to avoid or minimize OOO sequences on the destination host(s). Thus, the device may either implement packets hazards/barriers, or it may cutover to another link (for RR) when it deems fit. However, since there are multiple flows from source to destination, the device may generally not re-balance the in-order flows.

There are various RDMA transport modes such as RC (reliable connection), RD, and UD, and picking the correct LB-hints combination for their application’s requirements may be left up to the user. A user may also set an implementation-defined CA-LB mode and allow the CA-LB aware device to perform pre-defined performant LB on the packets. In such cases, a user may provide certain hints such as Collectives Type to assist the CA-LB-aware device and let the device do the rest.

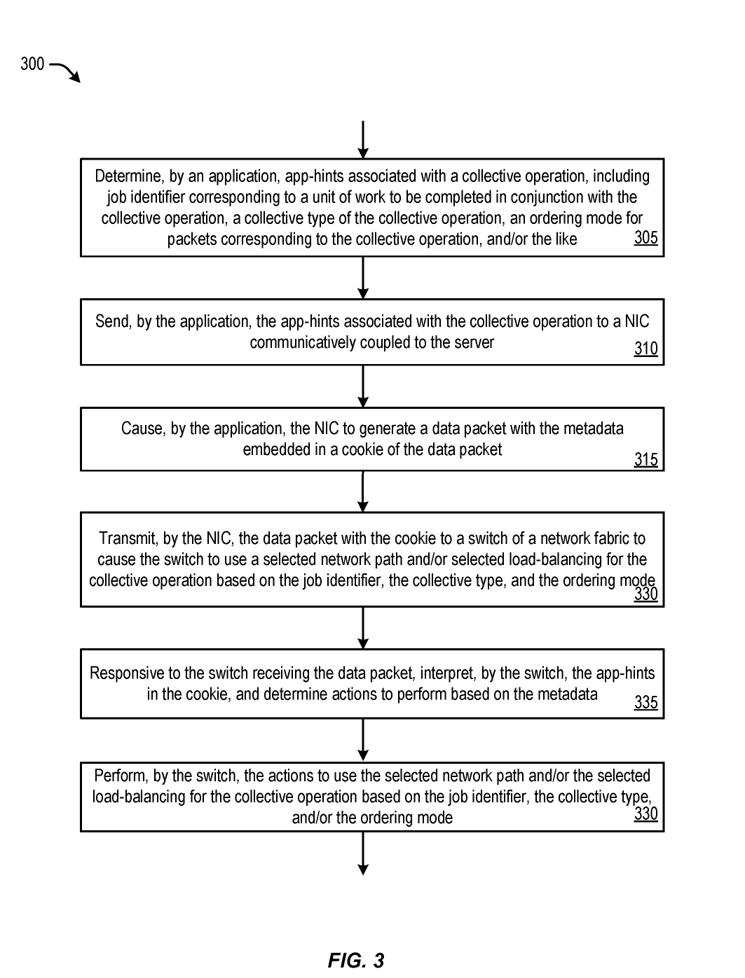

FIG. 3 illustrates one example method 300 to facilitate collectives-aware load balancing, in accordance with embodiments according to the present disclosure. One or a combination of the aspects of the method 300 may be performed in conjunction with one or more other aspects disclosed herein, and the method 300 is to be interpreted in view of other features disclosed herein and may be combined with one or more of such features in various embodiments. Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

As indicated by block 305, metadata (app-hints) associated with a collective operation may be determined by an application (e.g., application 116 or 126) of a server (e.g., server 102 or 104). The metadata may include one or a combination of a job identifier corresponding to a unit of work to be completed in conjunction with the collective operation, a collective type of the collective operation, an ordering mode for packets corresponding to the collective operation, and/or any of the other app-hints disclosed herein. For example, the ordering mode may correspond to an in-order mode, an out-of-order mode, or a selective out-of-order mode. For example, the ordering mode may correspond to an in-order mode, an out-of-order mode, or a selective out-of-order mode. The metadata may be determined based on predefined configurations stored in the application, runtime conditions, or user-defined policies to ensure alignment with the specific requirements of the collective operation, such as latency sensitivity, data integrity, or throughput optimization.

As indicated by block 310, the metadata associated with the collective operation may be sent by the application to a NIC (e.g., NIC 106, 106-1, 108, or 108-1). In some embodiments, the application may also send the metadata to the switch via the NIC. The application may send, via the NIC, a mapping of the metadata to particular actions to the switch. Such a mapping may have been previously sent to the switch so the switch can use the mapping to interpret the metadata and perform one or more actions corresponding to the use of the selected network path and/or the selected load-balancing for the collective operation. The mapping may be established during initialization or dynamically updated based on network conditions, workload priorities, or policy changes, ensuring the switch can adapt to evolving requirements while maintaining consistency in metadata interpretation.

As indicated by block 315, the NIC may be caused, by the application, to generate a data packet with the metadata embedded in a cookie of the data packet and to transmit the data packet with the cookie to a switch of a network fabric (e.g., network devices 110, 110-1, 112, 112-1, 114, and 114-1) to cause the switch to use a selected network path and/or selected load-balancing for the collective operation based at least in part on one or more of the job identifier, the collective type, and/or the ordering mode. The cookie may include a structured format, such as a header or identifier field, that the switch uses to reference the preconfigured mapping and determine the appropriate actions.

As indicated by block 320, the NIC may transmit the data packet with the cookie to the switch to cause the switch to use a selected network path and/or selected load-balancing for the collective operation based at least in part on one or more of the job identifier, the collective type, and/or the ordering mode. The transmission may leverage hardware acceleration within the NIC to embed the cookie efficiently and ensure minimal latency. The NIC may also prioritize the transmission of metadata-containing packets to ensure the switch receives the necessary instructions before processing the actual data payload.

As indicated by block 325, the switch may receive the data packet, interpret the metadata in the cookie, and determine one or more actions to perform based on the metadata. For example, the switch may use the mapping of metadata to actions to interpret the metadata in the cookie and determine the one or more actions to perform. The switch may reference a lookup table that maps specific metadata values (e.g., job identifiers, collective types, or ordering modes) to predefined network paths or load-balancing strategies. This mapping may ensure that the switch can execute the required actions without requiring additional communication with the application or NIC.

As indicated by block 330, the switch may perform the one or more actions to use the selected network path and/or the selected load-balancing for the collective operation based at least in part on one or more of the job identifier, the collective type, and/or the ordering mode. The switch may use the selected network path specified by the metadata. The switch may use the selected load-balancing for the collective operation to route the unit of work over one or more specified paths. The selected load-balancing may include routing traffic with a path group in round robin mode over links of the path group. When the cookie specifies an in-order mode, the switch may send the packets corresponding to the collective operation, including the data packet, in-order on the same link to another network device and/or a worker server in accordance with the metadata. This may ensure that packets are processed in the correct sequence at the destination, which is critical for applications requiring strict ordering, such as transactional workloads or real-time control systems. When the cookie specifies an out-of-order mode, the switch may send the packets corresponding to the collective operation, including the data packet, out-of-order across disparate links to one or more other network devices and/or one or more worker servers in accordance with the metadata. This may allow for parallel processing and reduced latency, which is beneficial for applications that can tolerate reordering at the destination, such as bulk data transfers or distributed computing tasks. When the cookie specifies a selective out-of-order mode, the switch may send a first subset of the packets corresponding to the collective operation in-order on the same link to another network device and/or a worker server and send a second subset of the packets out-of-order across disparate links to one or more other network devices and/or one or more worker servers in accordance with the metadata. This hybrid approach may enable fine-grained control over packet transmission, balancing the need for ordering in critical subsets of data with the performance benefits of parallel transmission for non-critical subsets.

Consequently, disclosed introduce a novel approach to network optimization in distributed systems by embedding application-specific metadata—referred to as app-hints—into data packets as structured cookies. This may enable network switches to autonomously select routing paths and load-balancing strategies based on dynamic application requirements, such as job identifiers, collective operation types, and ordering modes (e.g., in-order, out-of-order, or selective out-of-order). Advantageously, disclosed embodiments may align network behavior with application needs in real time, reducing latency for critical tasks while maximizing throughput for bulk transfers. The use of hardware-accelerated metadata embedding in the NIC ensures minimal overhead, while the switch’s preconfigured mappings may allow autonomous decision-making without reliance on application-NIC communication, enhancing scalability and efficiency. The advantages of disclosed embodiments may be further underscored by the introduction of a selective out-of-order mode, which permits hybrid data transmission strategies (e.g., sending critical data subsets in-order and non-critical data out-of-order). Disclosed embodiments may provide a flexible, application-driven framework for optimizing network performance in complex distributed environments. Particularly advantageous in AI/ML training, where large-scale workloads often rely on collective operations (e.g., AllReduce) running for days or weeks, disclosed embodiments may ensure efficient communication by dynamically adapting to the high-throughput, low-latency demands of these workloads. By enabling switches to autonomously prioritize critical data and optimize path selection for extended collective operations, disclosed embodiments may significantly reduce bottlenecks and improve the scalability of AI/ML training in distributed systems. Furthermore, the integration of metadata-driven load-balancing strategies allows switches to dynamically distribute traffic across multiple paths in real time, ensuring uniform utilization of network resources and preventing congestion during prolonged AI/ML training sessions. In various embodiments, this technology may be implemented in one or a combination of the following.

### Examples of Cloud Networks

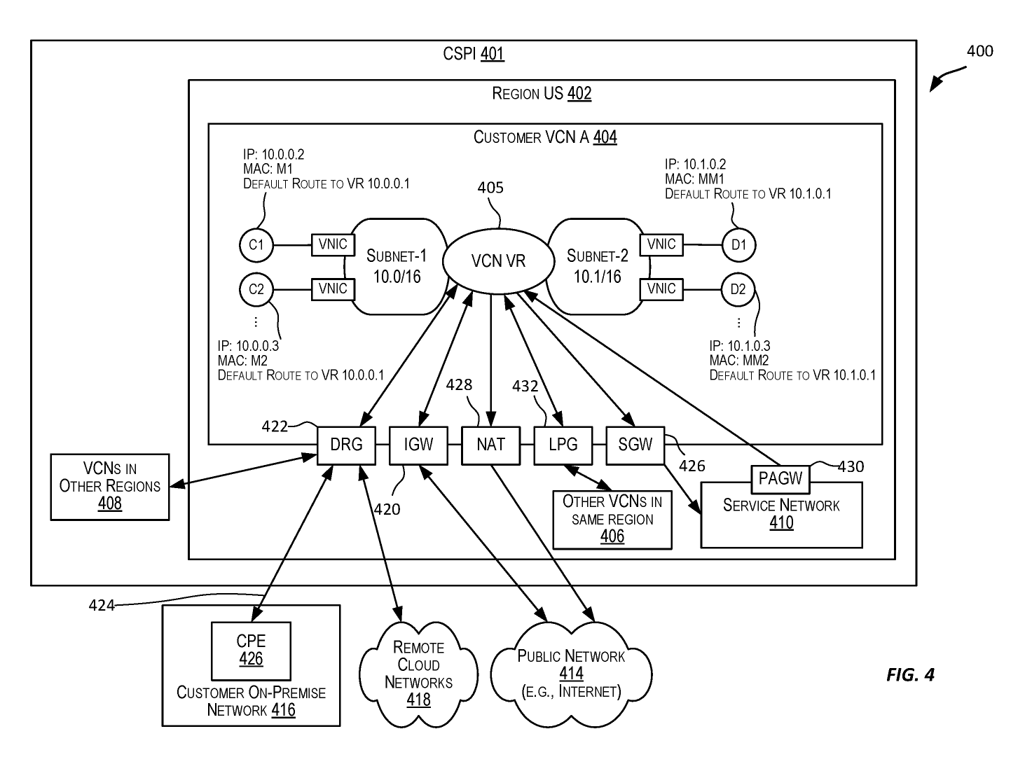

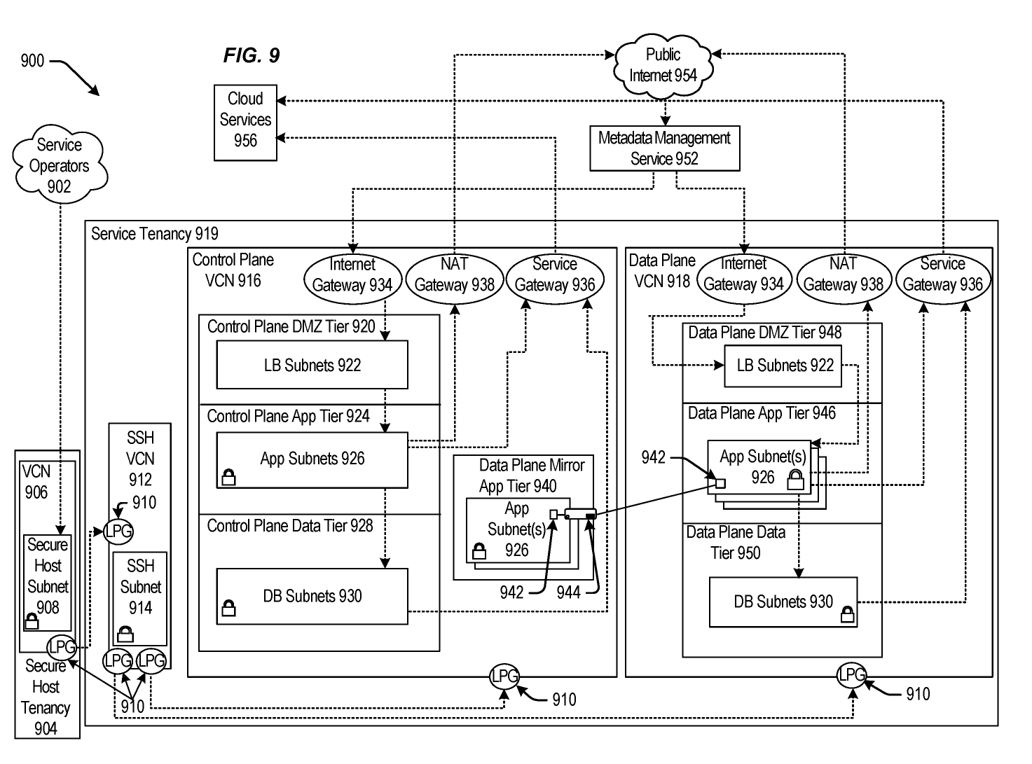

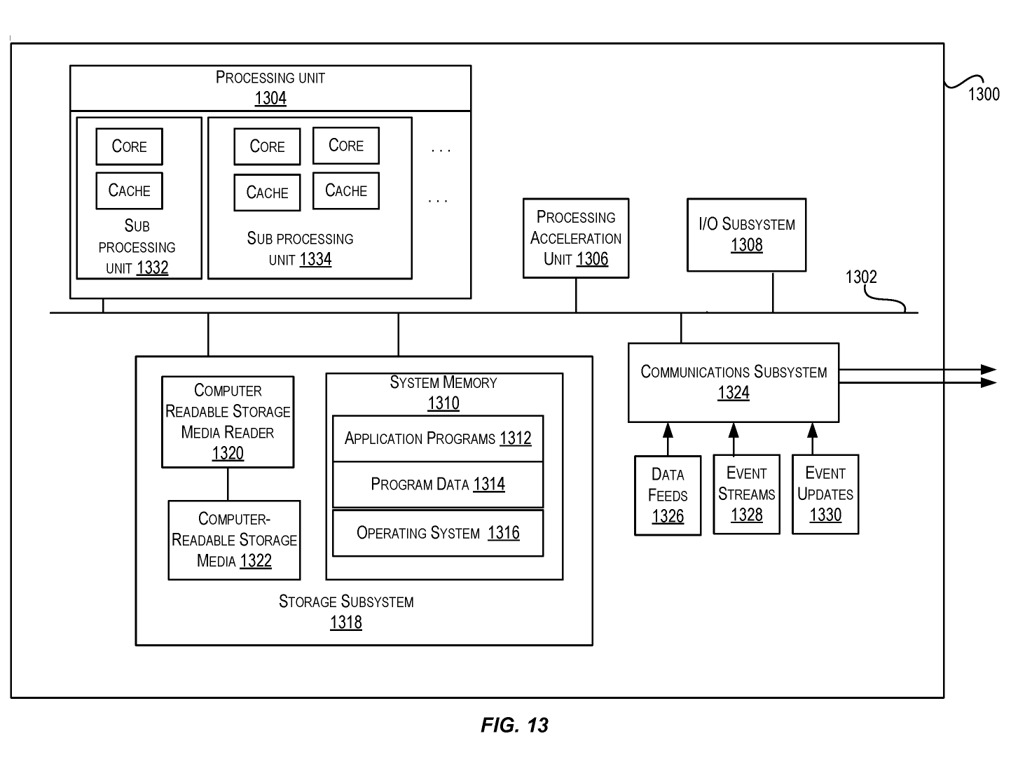

FIGS. 4-8 and the associated description provided below describe networking concepts including network virtualization, substrate networks, overlay networks, VNICs, etc., and provide examples of environments in which certain embodiments of collectives-aware load balancing described in this disclosure may be implemented. FIGS. 9-12 depict examples of architectures for implementing cloud infrastructures for providing one or more cloud services, where the infrastructures may incorporate teachings described herein. FIG. 13 depicts a block diagram illustrating an example computer system or device, according to at least one embodiment.

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN — IETF RFC 8348), Virtual Private Networks (VPNs) (e.g., MPLS Layer-3 Virtual Private Networks (RFC 5364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint ("endpoint") refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the "home" region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints ("public endpoints") over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 11.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 11.0.0.0/24 and 11.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general, a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 11.0.0.0/24 and 11.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways ("gateways") associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 11.0/16 and 11.1/16, respectively. For the first subnet within the VCN with address range 11.0/16, an address from this range is reserved for a port of the VCN VR for that subnet. In some instances, the first IP address from the range may be reserved for the VCN VR. For example, for the subnet with overlay IP address range 11.0/16, IP address 11.0.0.1 may be reserved for a port of the VCN VR for that subnet. For the second subnet within the same VCN with address range 11.1/16, the VCN VR may have a port for that second subnet with IP address 11.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 9, 10, 11, and 12 (see references 916, 1016, 1116, and 1216) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 4, 5, 6, 7, 8, 9, 10, 11, and 12, and are described below. FIG. 4 is a high-level diagram of a distributed environment 400 showing an overlay or customer VCN hosted by CSPI according to certain embodiments. The distributed environment depicted in FIG. 4 includes multiple components in the overlay network. Distributed environment 400 depicted in FIG. 4 is merely an example and is not intended to unduly limit the scope of claimed embodiments. Many variations, alternatives, and modifications are possible. For example, in some implementations, the distributed environment depicted in FIG. 4 may have more or fewer systems or components than those shown in FIG. 1, may combine two or more systems, or may have a different configuration or arrangement of systems.

As shown in the example depicted in FIG. 4, distributed environment 400 comprises CSPI 401 that provides services and resources that customers can subscribe to and use to build their virtual cloud networks (VCNs). In certain embodiments, CSPI 401 offers IaaS services to subscribing customers. The data centers within CSPI 401 may be organized into one or more regions. One example region "Region US" 402 is shown in FIG. 4. A customer has configured a customer VCN 404 for region 402. The customer may deploy various compute instances on VCN 404, where the compute instances may include virtual machines or bare metal instances. Examples of instances include applications, database, load balancers, and the like.

In the embodiment depicted in FIG. 4, customer VCN 404 comprises two subnets, namely, "Subnet-1" and "Subnet-2", each subnet with its own CIDR IP address range. In FIG. 4, the overlay IP address range for Subnet-1 is 11.0/16 and the address range for Subnet-2 is 11.1/16. A VCN Virtual Router 405 represents a logical gateway for the VCN that enables communications between subnets of the VCN 404, and with other endpoints outside the VCN. VCN VR 405 is configured to route traffic between VNICs in VCN 404 and gateways associated with VCN 404. VCN VR 405 provides a port for each subnet of VCN 404. For example, VR 405 may provide a port with IP address 11.0.0.1 for Subnet-1 and a port with IP address 11.1.0.1 for Subnet-2.

Multiple compute instances may be deployed on each subnet, where the compute instances can be virtual machine instances, and/or bare metal instances. The compute instances in a subnet may be hosted by one or more host machines within CSPI 401. A compute instance participates in a subnet via a VNIC associated with the compute instance. For example, as shown in FIG. 4, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 4, compute instance C1 has an overlay IP address of 11.0.0.2 and a MAC address of M1, while compute instance C2 has an private overlay IP address of 11.0.0.3 and a MAC address of M2. Each compute instance in Subnet-1, including compute instances C1 and C2, has a default route to VCN VR 405 using IP address 11.0.0.1, which is the IP address for a port of VCN VR 405 for Subnet-1.

Subnet-2 can have multiple compute instances deployed on it, including virtual machine instances and/or bare metal instances. For example, as shown in FIG. 4, compute instances D1 and D2 are part of Subnet-2 via VNICs associated with the respective compute instances. In the embodiment depicted in FIG. 4, compute instance D1 has an overlay IP address of 11.1.0.2 and a MAC address of MM1, while compute instance D2 has an private overlay IP address of 11.1.0.3 and a MAC address of MM2. Each compute instance in Subnet-2, including compute instances D1 and D2, has a default route to VCN VR 405 using IP address 11.1.0.1, which is the IP address for a port of VCN VR 405 for Subnet-2.

VCN A 404 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 404 can communicate with various different endpoints. These endpoints may include endpoints that are hosted by CSPI 500 and endpoints outside CSPI 500. Endpoints that are hosted by CSPI 401 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 406 or 410, communications between a compute instance in Subnet-1 and an endpoint in service network 410 in the same region); or an endpoint in a VCN in a different region (e.g., communications between a compute instance in Subnet-1 and an endpoint in a VCN in a different region 408). A compute instance in a subnet hosted by CSPI 401 may also communicate with endpoints that are not hosted by CSPI 401 (i.e., are outside CSPI 401). These outside endpoints include endpoints in the customer's on-premise network 416, endpoints within other remote cloud hosted networks 418, public endpoints 414 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 4 wants to send a packet to compute instance D1 in Subnet-2, the packet is first processed by the VNIC associated with compute instance C1. The VNIC associated with compute instance C1 is configured to route the packet to the VCN VR 405 using default route or port 11.0.0.1 of the VCN VR. VCN VR 405 is configured to route the packet to Subnet-2 using port 11.1.0.1. The packet is then received and processed by the VNIC associated with D1 and the VNIC forwards the packet to compute instance D1.

For a packet to be communicated from a compute instance in VCN 404 to an endpoint that is outside VCN 404, the communication is facilitated by the VNIC associated with the source compute instance, VCN VR 405, and gateways associated with VCN 404. One or more types of gateways may be associated with VCN 404. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 404. The packet may be first processed by the VNIC associated with source compute instance C1. The VNIC processing determines that the destination for the packet is outside the Subnet-1 of C1. The VNIC associated with C1 may forward the packet to VCN VR 405 for VCN 404. VCN VR 405 then processes the packet and as part of the processing, based upon the destination for the packet, determines a particular gateway associated with VCN 404 as the next hop for the packet. VCN VR 405 may then forward the packet to the particular identified gateway. For example, if the destination is an endpoint within the customer's on-premise network, then the packet may be forwarded by VCN VR 405 to Dynamic Routing Gateway (DRG) gateway 422 configured for VCN 404. The packet may then be forwarded from the gateway to a next hop to facilitate communication of the packet to it final intended destination.

Various different types of gateways may be configured for a VCN. Examples of gateways that may be configured for a VCN are depicted in FIG. 4 and described below. Examples of gateways associated with a VCN are also depicted in FIGS. 9, 10, 11, and 12 (for example, gateways referenced by reference numbers 934, 936, 938, 1034, 1036, 1038, 1134, 1136, 1138, 1234, 1236, and 1238) and described below. As shown in the embodiment depicted in FIG. 4, a Dynamic Routing Gateway (DRG) 422 may be added to or be associated with customer VCN 404 and provides a path for private network traffic communication between customer VCN 404 and another endpoint, where the another endpoint can be the customer's on-premise network 416, a VCN 408 in a different region of CSPI 401, or other remote cloud networks 418 not hosted by CSPI 401. Customer on-premise network 416 may be a customer network or a customer data center built using the customer's resources. Access to customer on-premise network 416 is generally very restricted. For a customer that has both a customer on-premise network 416 and one or more VCNs 404 deployed or hosted in the cloud by CSPI 401, the customer may want their on-premise network 416 and their cloud-based VCN 404 to be able to communicate with each other. This enables a customer to build an extended hybrid environment encompassing the customer's VCN 404 hosted by CSPI 401 and their on-premises network 416. DRG 422 enables this communication. To enable such communications, a communication channel 424 is set up where one endpoint of the channel is in customer on-premise network 416 and the other endpoint is in CSPI 401 and connected to customer VCN 404. Communication channel 424 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 416 that forms one end point for communication channel 424 is referred to as the customer premise equipment (CPE), such as CPE 426 depicted in FIG. 4. On the CSPI 401 side, the endpoint may be a host machine executing DRG 422.

In certain embodiments, a Remote Peering Connection (RPC) can be added to a DRG, which allows a customer to peer one VCN with another VCN in a different region. Using such an RPC, customer VCN 404 can use DRG 422 to connect with a VCN 408 in another region. DRG 422 may also be used to communicate with other remote cloud networks 418, not hosted by CSPI 401 such as a Microsoft Azure cloud, Amazon AWS cloud, and others.

As shown in FIG. 4, an Internet Gateway (IGW) 420 may be configured for customer VCN 404 the enables a compute instance on VCN 404 to communicate with public endpoints 414 accessible over a public network such as the Internet. IGW 420 is a gateway that connects a VCN to a public network such as the Internet. IGW 420 enables a public subnet (where the resources in the public subnet have public overlay IP addresses) within a VCN, such as VCN 404, direct access to public endpoints 412 on a public network 414 such as the Internet. Using IGW 420, connections can be initiated from a subnet within VCN 404 or from the Internet.

A Network Address Translation (NAT) gateway 428 can be configured for customer's VCN 404 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 404, with private access to public endpoints on the Internet. In NAT gateways, connections can be initiated only from the private subnet to the public Internet and not from the Internet to the private subnet.

In certain embodiments, a Service Gateway (SGW) 426 can be configured for customer VCN 404 and provides a path for private network traffic between VCN 404 and supported services endpoints in a service network 410. In certain embodiments, service network 410 may be provided by the CSP and may provide various services. An example of such a service network is Oracle’s Services Network, which provides various services that can be used by customers. For example, a compute instance (e.g., a database system) in a private subnet of customer VCN 404 can back up data to a service endpoint (e.g., Object Storage) without needing public IP addresses or access to the Internet. In certain embodiments, a VCN can have only one SGW, and connections can only be initiated from a subnet within the VCN and not from service network 410. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 426 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 432 is a gateway that can be added to customer VCN 404 and enables VCN 404 to peer with another VCN in the same region. Peering means that the VCNs communicate using private IP addresses, without the traffic traversing a public network such as the Internet or without routing the traffic through the customer's on-premises network 416. In preferred embodiments, a VCN has a separate LPG for each peering it establishes. Local Peering or VCN Peering is a common practice used to establish network connectivity between different applications or infrastructure management functions.

Service providers, such as providers of services in service network 410, may provide access to services using different access models. According to a public access model, services may be exposed as public endpoints that are publicly accessible by compute instance in a customer VCN via a public network such as the Internet and or may be privately accessible via SGW 426. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 430 is a gateway resource that can be attached to a service provider VCN (e.g., a VCN in service network 410) that acts as an ingress/egress point for all traffic from/to customer subnet private endpoints. PAGW 430 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 430 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 432 and the PE in the customer's VCN.

A customer can control routing in a VCN at the subnet level, so the customer can specify which subnets in the customer's VCN, such as VCN 404, use each gateway. A VCN's route tables are used to decide if traffic is allowed out of a VCN through a particular gateway. For example, in a particular instance, a route table for a public subnet within customer VCN 404 may send non-local traffic through IGW 420. The route table for a private subnet within the same customer VCN 404 may send traffic destined for CSP services through SGW 426. All remaining traffic may be sent via the NAT gateway 428. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 4389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 404) can be categorized as public access, private access, or dedicated access. Public access refers to an access model where a public IP address or a NAT is used to access a public endpoint. Private access enables customer workloads in VCN 404 with private IP addresses (e.g., resources in a private subnet) to access services without traversing a public network such as the Internet. In certain embodiments, CSPI 401 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

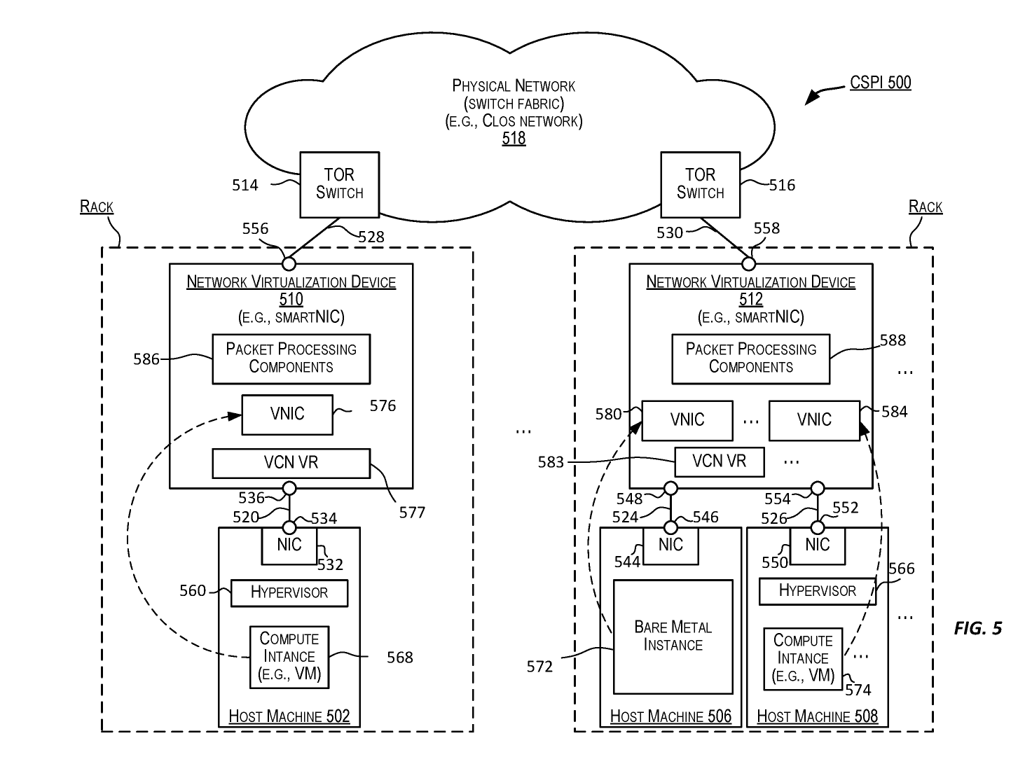

FIG. 4 and the accompanying description above describes various virtualized components in an example virtual network. As described above, the virtual network is built on the underlying physical or substrate network. FIG. 5 depicts a simplified architectural diagram of the physical components in the physical network within CSPI 500 that provide the underlay for the virtual network according to certain embodiments. As shown, CSPI 500 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 500 are provisioned for the customer. Customers can then build their own cloud-based (i.e., CSPI-hosted) customizable and private virtual networks using physical compute, memory, and networking resources provided by CSPI 500. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 500 provides infrastructure and a set of complementary cloud services that enable customers to build and run a wide range of applications and services in a highly available hosted environment.

In the example embodiment depicted in FIG. 5, the physical components of CSPI 500 include one or more physical host machines or physical servers (e.g., 502, 506, 508), network virtualization devices (NVDs) (e.g., 510, 512), top-of-rack (TOR) switches (e.g., 514, 516), and a physical network (e.g., 518), and switches in physical network 518. The physical host machines or servers may host and execute various compute instances that participate in one or more subnets of a VCN. The compute instances may include virtual machine instances, and bare metal instances. For example, the various compute instances depicted in FIG. 4 may be hosted by the physical host machines depicted in FIG. 5. The virtual machine compute instances in a VCN may be executed by one host machine or by multiple different host machines. The physical host machines may also host virtual host machines, container-based hosts or functions, and the like. The VNICs and VCN VR depicted in FIG. 4 may be executed by the NVDs depicted in FIG. 5. The gateways depicted in FIG. 4 may be executed by the host machines and/or by the NVDs depicted in FIG. 5.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 5, host machines 502 and 508 execute hypervisors 560 and 566, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 5, hypervisor 560 may sit on top of the OS of host machine 502 and enables the computing resources (e.g., processing, memory, and networking resources) of host machine 502 to be shared between compute instances (e.g., virtual machines) executed by host machine 502. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 5 may have the same or different types of hypervisors.

A compute instance can be a virtual machine instance or a bare metal instance. In FIG. 5, compute instances 568 on host machine 502 and 574 on host machine 508 are examples of virtual machine instances. Host machine 506 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 5, host machine 502 executes a virtual machine compute instance 568 that is associated with VNIC 576, and VNIC 576 is executed by NVD 510 connected to host machine 502. As another example, bare metal instance 572 hosted by host machine 506 is associated with VNIC 580 that is executed by NVD 512 connected to host machine 506. As yet another example, VNIC 584 is associated with compute instance 574 executed by host machine 508, and VNIC 584 is executed by NVD 512 connected to host machine 508.

For compute instances hosted by a host machine, an NVD connected to that host machine also executes VCN VRs corresponding to VCNs of which the compute instances are members. For example, in the embodiment depicted in FIG. 5, NVD 510 executes VCN VR 577 corresponding to the VCN of which compute instance 568 is a member. NVD 512 may also execute one or more VCN VRs 583 corresponding to VCNs corresponding to the compute instances hosted by host machines 506 and 508.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 5, host machine 502 is connected to NVD 510 using link 520 that extends between a port 534 provided by a NIC 532 of host machine 502 and between a port 536 of NVD 510. Host machine 506 is connected to NVD 512 using link 524 that extends between a port 546 provided by a NIC 544 of host machine 506 and between a port 548 of NVD 512. Host machine 508 is connected to NVD 512 using link 526 that extends between a port 552 provided by a NIC 550 of host machine 508 and between a port 554 of NVD 512.

The NVDs are in turn connected via communication links to top-of-the-rack (TOR) switches, which are connected to physical network 518 (also referred to as the switch fabric). In certain embodiments, the links between a host machine and an NVD, and between an NVD and a TOR switch are Ethernet links. For example, in FIG. 5, NVDs 510 and 512 are connected to TOR switches 514 and 516, respectively, using links 528 and 530. In certain embodiments, the links 520, 524, 526, 528, and 530 are Ethernet links. The collection of host machines and NVDs that are connected to a TOR is sometimes referred to as a rack.

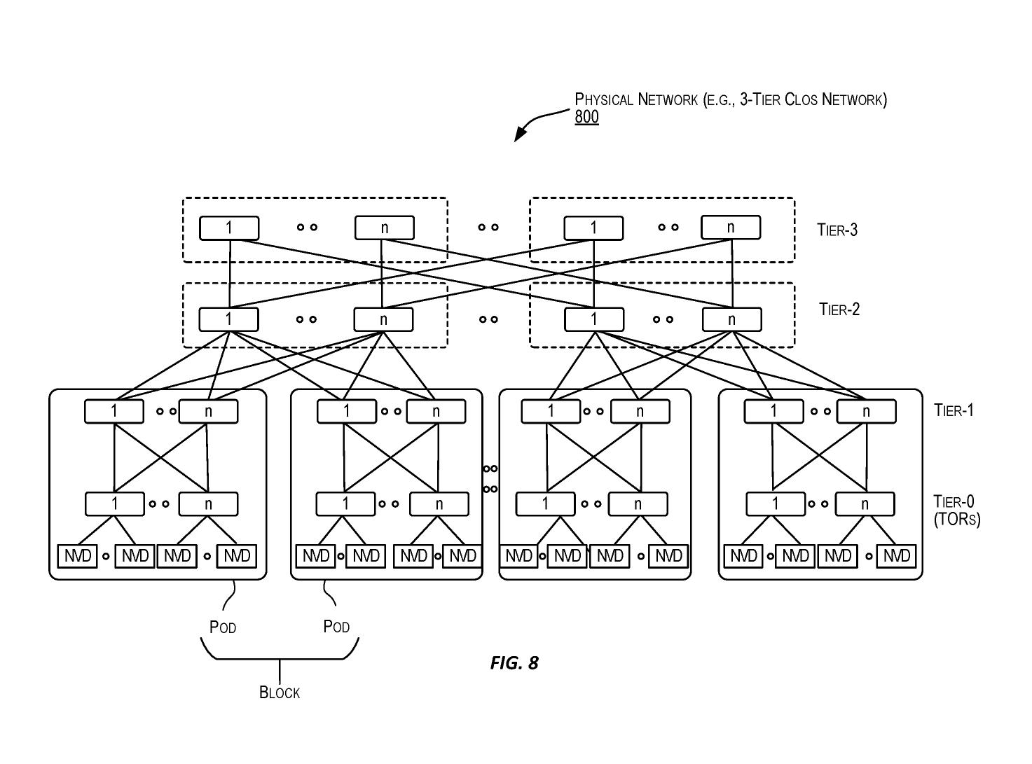

Physical network 518 provides a communication fabric that enables TOR switches to communicate with each other. Physical network 518 can be a multi-tiered network. In certain implementations, physical network 518 is a multi-tiered Clos network of switches, with TOR switches 514 and 516 representing the leaf level nodes of the multi-tiered and multi-node physical switching network 518. Different Clos network configurations are possible including but not limited to a 2-tier network, a 4-tier network, a 5-tier network, a 6-tier network, and in general a "n"-tiered network. An example of a Clos network is depicted in FIG. 8 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 5, host machine 502 is connected to NVD 510 via NIC 532 of host machine 502. In a many-to-one configuration, multiple host machines are connected to one NVD. For example, in FIG. 5, host machines 506 and 508 are connected to the same NVD 512 via NICs 544 and 550, respectively.

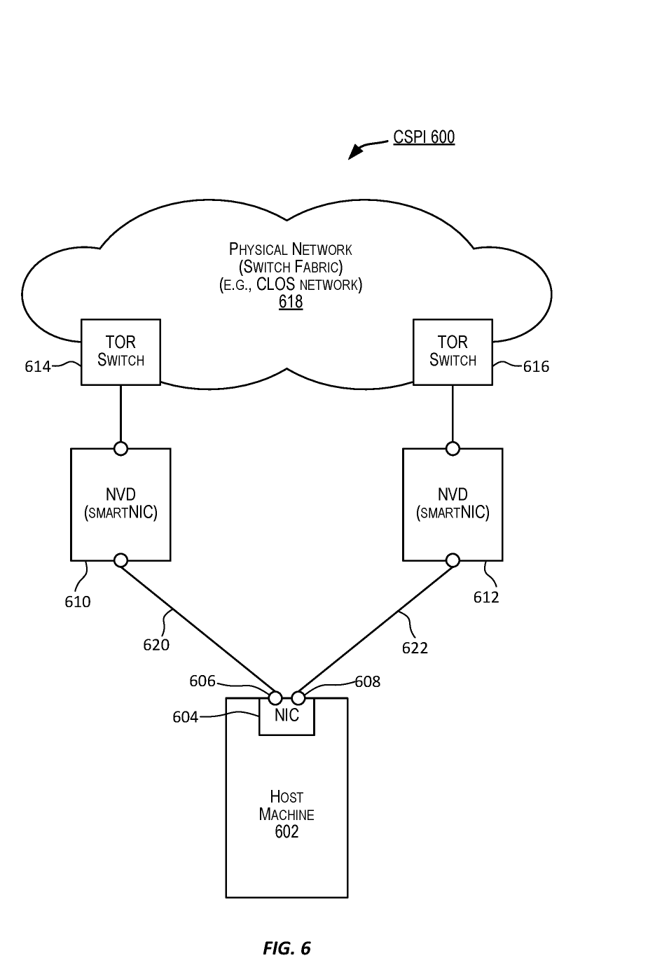

In a one-to-many configuration, one host machine is connected to multiple NVDs. FIG. 6 shows an example within CSPI 600 where a host machine is connected to multiple NVDs. As shown in FIG. 6, host machine 602 comprises a network interface card (NIC) 604 that includes multiple ports 606 and 608. Host machine 600 is connected to a first NVD 610 via port 606 and link 620, and connected to a second NVD 612 via port 608 and link 622. Ports 606 and 608 may be Ethernet ports and the links 620 and 622 between host machine 602 and NVDs 610 and 612 may be Ethernet links. NVD 610 is in turn connected to a first TOR switch 614 and NVD 612 is connected to a second TOR switch 616. The links between NVDs 610 and 612, and TOR switches 614 and 616 may be Ethernet links. TOR switches 614 and 616 represent the Tier-0 switching devices in multi-tiered physical network 618.

The arrangement depicted in FIG. 6 provides two separate physical network paths to and from physical switch network 618 to host machine 602: a first path traversing TOR switch 614 to NVD 610 to host machine 602, and a second path traversing TOR switch 616 to NVD 612 to host machine 602. The separate paths provide for enhanced availability (referred to as high availability) of host machine 602. If there are problems in one of the paths (e.g., a link in one of the paths goes down) or devices (e.g., a particular NVD is not functioning), then the other path may be used for communications to/from host machine 602.

In the configuration depicted in FIG. 6, the host machine is connected to two different NVDs using two different ports provided by a NIC of the host machine. In other embodiments, a host machine may include multiple NICs that enable connectivity of the host machine to multiple NVDs.

Referring back to FIG. 5, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 5, the NVDs 510 and 512 may be implemented as smartNICs that are connected to host machines 502, and host machines 506 and 508, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 500. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 5, an NVD may comprise multiple physical ports that enable it to be connected to one or more host machines and to one or more TOR switches. A port on an NVD can be classified as a host-facing port (also referred to as a "south port") or a network-facing or TOR-facing port (also referred to as a "north port"). A host-facing port of an NVD is a port that is used to connect the NVD to a host machine. Examples of host-facing ports in FIG. 5 include port 536 on NVD 510, and ports 548 and 554 on NVD 512. A network-facing port of an NVD is a port that is used to connect the NVD to a TOR switch. Examples of network-facing ports in FIG. 5 include port 556 on NVD 510, and port 558 on NVD 512. As shown in FIG. 5, NVD 510 is connected to TOR switch 514 using link 528 that extends from port 556 of NVD 510 to the TOR switch 514. Likewise, NVD 512 is connected to TOR switch 516 using link 530 that extends from port 558 of NVD 512 to the TOR switch 516.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 9, 10, 11, and 12 (see references 916, 1016, 1116, and 1216) and described below. Examples of a VCN Data Plane are depicted in FIGS. 9, 10, 11, and 12 (see references 918, 1018, 1118, and 1218) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 5, NVD 510 executes the functionality for VNIC 576 that is associated with compute instance 568 hosted by host machine 502 connected to NVD 510. As another example, NVD 512 executes VNIC 580 that is associated with bare metal compute instance 572 hosted by host machine 506 and executes VNIC 584 that is associated with compute instance 574 hosted by host machine 508. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 5, NVD 510 executes VCN VR 577 corresponding to the VCN to which compute instance 568 belongs. NVD 512 executes one or more VCN VRs 583 corresponding to one or more VCNs to which compute instances hosted by host machines 506 and 508 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as "packet processing components" shown in FIG. 5. For example, NVD 510 comprises packet processing components 586 and NVD 512 comprises packet processing components 588. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 4 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 4 may be executed or hosted by one or more of the physical components depicted in FIG. 5. For example, the compute instances in a VCN may be executed or hosted by one or more host machines depicted in FIG. 5. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 5, a packet originating from compute instance 568 may be communicated from host machine 502 to NVD 510 over link 520 (using NIC 532). On NVD 510, VNIC 576 is invoked since it is the VNIC associated with source compute instance 568. VNIC 576 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 500 and endpoints outside CSPI 500. Endpoints hosted by CSPI 500 may include instances in the same VCN or other VCNs, which may be the customer's VCNs, or VCNs not belonging to the customer. Communications between endpoints hosted by CSPI 500 may be performed over physical network 518. A compute instance may also communicate with endpoints that are not hosted by CSPI 500, or are outside CSPI 500. Examples of these endpoints include endpoints within a customer's on-premise network or data center, or public endpoints accessible over a public network such as the Internet. Communications with endpoints outside CSPI 500 may be performed over public networks (e.g., the Internet) (not shown in FIG. 5) or private networks (not shown in FIG. 5) using various communication protocols.

The architecture of CSPI 500 depicted in FIG. 5 is merely an example and is not intended to be limiting. Variations, alternatives, and modifications are possible in alternative embodiments. For example, in some implementations, CSPI 500 may have more or fewer systems or components than those shown in FIG. 5, may combine two or more systems, or may have a different configuration or arrangement of systems. The systems, subsystems, and other components depicted in FIG. 5 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

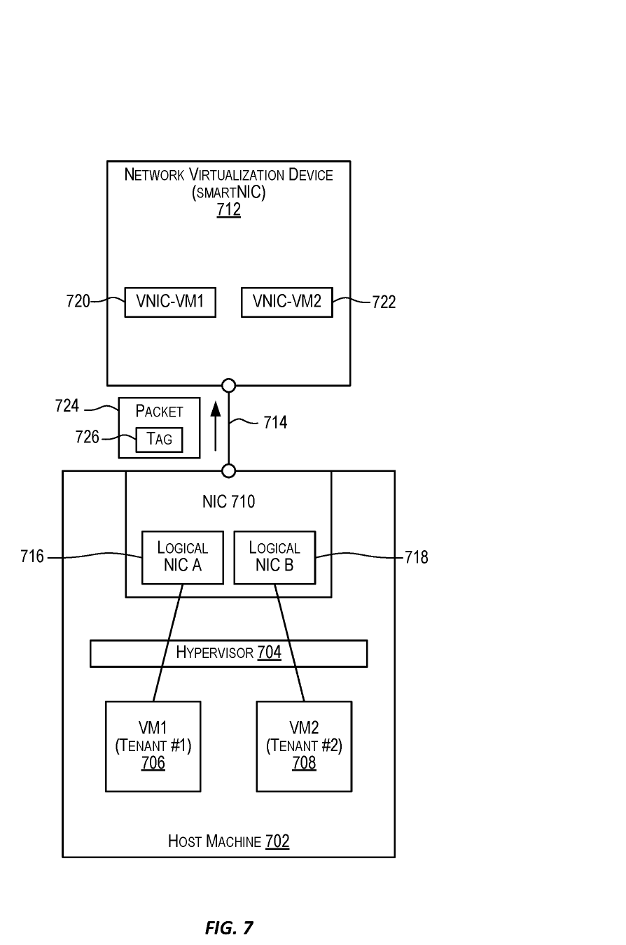

FIG. 7 depicts connectivity between a host machine and an NVD for providing I/O virtualization for supporting multitenancy according to certain embodiments. As depicted in FIG. 7, host machine 702 executes a hypervisor 704 that provides a virtualized environment. Host machine 702 executes two virtual machine instances, VM1 706 belonging to customer/tenant #1 and VM2 708 belonging to customer/tenant #2. Host machine 702 comprises a physical NIC 710 that is connected to an NVD 712 via link 714. Each of the compute instances is attached to a VNIC that is executed by NVD 712. In the embodiment in FIG. 7, VM1 706 is attached to VNIC-VM1 720 and VM2 708 is attached to VNIC-VM2 722.

As shown in FIG. 7, NIC 710 comprises two logical NICs, logical NIC A 716 and logical NIC B 718. Each virtual machine is attached to and configured to work with its own logical NIC. For example, VM1706 is attached to logical NIC A 716 and VM2 708 is attached to logical NIC B 718. Even though host machine 702 comprises only one physical NIC 710 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 716 for Tenant #1 and a separate VLAN ID is assigned to logical NIC B 718 for Tenant #2. When a packet is communicated from VM1706, a tag assigned to Tenant #1 is attached to the packet by the hypervisor and the packet is then communicated from host machine 702 to NVD 712 over link 714. In a similar manner, when a packet is communicated from VM2708, a tag assigned to Tenant #2 is attached to the packet by the hypervisor and the packet is then communicated from host machine 702 to NVD 712 over link 714. Accordingly, a packet 724 communicated from host machine 702 to NVD 712 has an associated tag 726 that identifies a specific tenant and associated VM. On the NVD, for a packet 724 received from host machine 702, the tag 726 associated with the packet is used to determine whether the packet is to be processed by VNIC-VM1720 or by VNIC-VM2 722. The packet is then processed by the corresponding VNIC. The configuration depicted in FIG. 7 enables each tenant's compute instance to believe that they own their own host machine and NIC. The setup depicted in FIG. 7 provides for I/O virtualization for supporting multi-tenancy.

FIG. 8 depicts a simplified block diagram of a physical network 800 according to certain embodiments. The embodiment depicted in FIG. 8 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 8 is a 4-tiered network comprising tiers 1, 2, and 4. The TOR switches 804 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 8, a set of "n" Tier-0 TOR switches are connected to a set of "n" Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of "n" Tier-2 switches (sometimes referred to as spine switches). There can be several blocks in the physical network topology. The Tier-2 switches are in turn connected to "n" Tier-3 switches (sometimes referred to as super-spine switches). Communication of packets over physical network 800 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0- switch to another NVD connected to a Tier-0 switch) is fixed. For example, in a 4-Tiered Clos network at most seven hops are needed for a packet to reach from one NVD to another NVD, where the source and target NVDs are connected to the leaf tier of the Clos network. Likewise, in a 5-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:

ocid1.<RESOURCE TYPE>.<REALM>.[REGION][.FUTURE USE].<UNIQUE ID>

where,

ocid1: The literal string indicating the version of the CID;

resource type: The type of resource (for example, instance, volume, VCN, subnet, user, group, and so on);

realm: The realm the resource is in. Example values are "c1" for the commercial realm, "c2" for the Government Cloud realm, or "c3" for the Federal Government Cloud realm, etc. Each realm may have its own domain name;

region: The region the resource is in. If the region is not applicable to the resource, this part might be blank;

future use: Reserved for future use.

unique ID: The unique portion of the ID. The format may vary depending on the type of resource or service.

### Examples of Cloud Infrastructure

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 9, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users’, or other customers’, resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

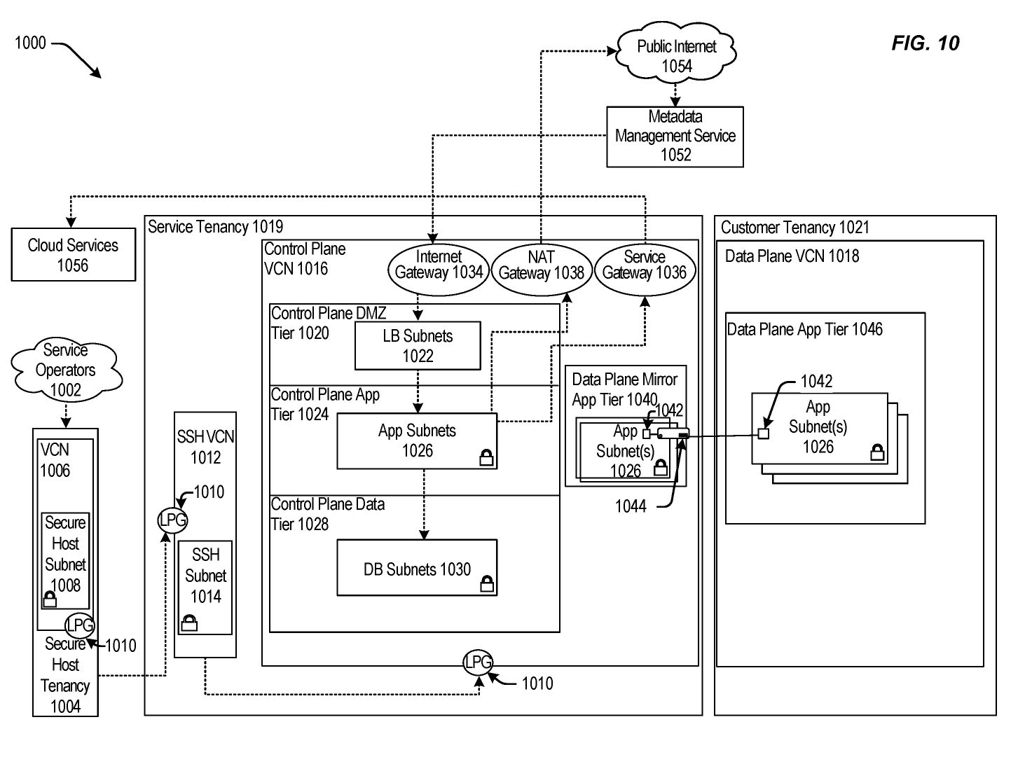

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

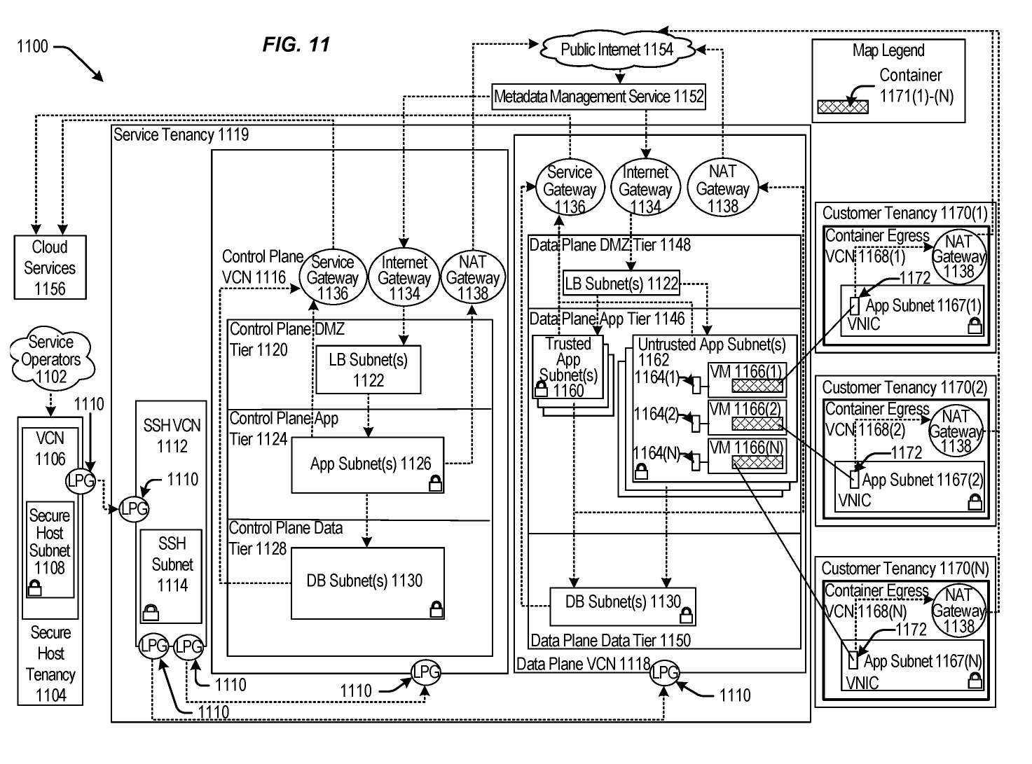

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

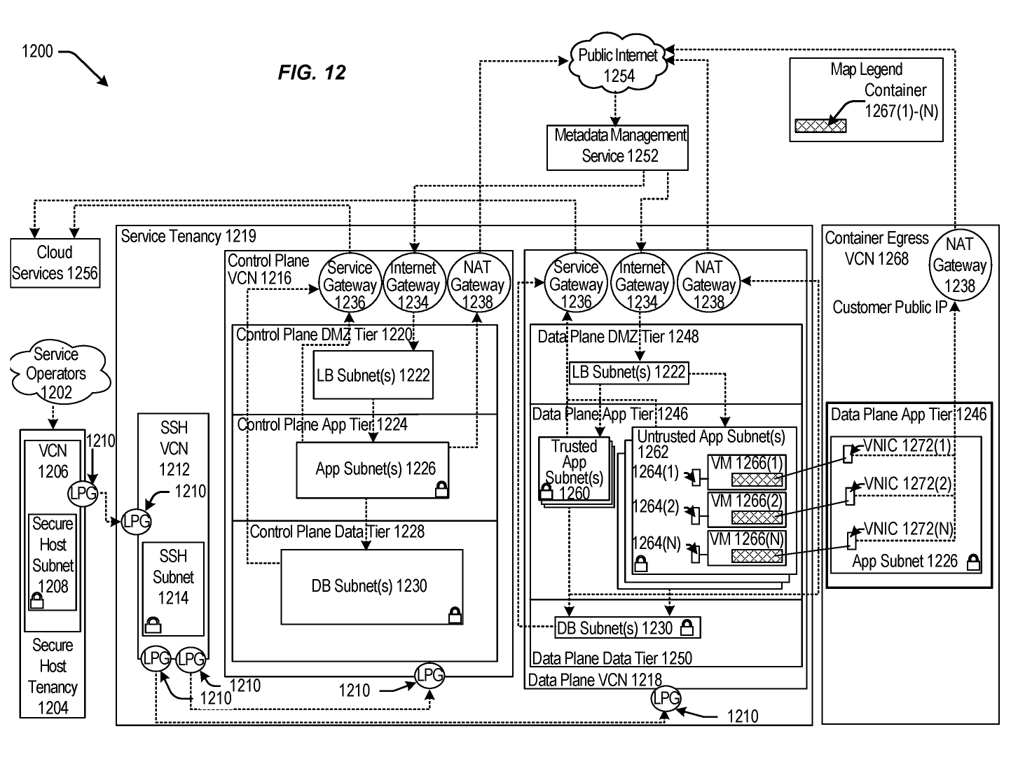

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 460 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 4D scanners, 4D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term "output device" is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random-access memory (RAM)) and/or non-volatile memory (such as read-only memory (ROM), flash memory, etc.) Different types of RAM configurations may be provided including a static random-access memory (SRAM), a dynamic random-access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 4G, 5G or EDGE (enhanced data rates for global evolution), Wi-Fi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed:

1. A method comprising:
determining, by an application of a server, metadata associated with a collective operation, wherein the metadata specifies at least one of:
a job identifier corresponding to a unit of work to be completed in conjunction with the collective operation;
a collective type of the collective operation; and/or
an ordering mode for packets corresponding to the collective operation;
sending, by the application, the metadata associated with the collective operation to a network interface card (NIC) communicatively coupled to the server; and
causing, by the application, the NIC to transmit a data packet with the metadata embedded in a cookie of the data packet to a switch of a network fabric to cause the switch to use a selected network path and/or selected load-balancing for the collective operation based at least in part on one or more of the job identifier, the collective type, and/or the ordering mode.

2. The method as recited in claim 1, wherein the ordering mode corresponds to an in-order mode, and the packets corresponding to the collective operation, including the data packet, are sent by the switch in-order on the same link in accordance with the metadata.

3. The method as recited in claim 1, wherein the ordering mode corresponds to an out-of-order mode, and the packets corresponding to the collective operation, including the data packet, are sent by the switch out-of-order across disparate links in accordance with the metadata.

4. The method as recited in claim 1, wherein the ordering mode corresponds to a selective out-of-order mode, and a first subset of the packets corresponding to the collective operation are sent in-order on the same link while a second subset of the packets are sent out-of-order across disparate links in accordance with the metadata.

5. The method as recited in claim 1, further comprising sending, by the application, the metadata associated with the collective operation to the switch.

6. The method as recited in claim 1, further comprising sending, by the application via the NIC, a mapping of the metadata to particular actions to the switch, wherein the switch uses the mapping to interpret the metadata and perform one or more actions corresponding to the use of the selected network path and/or the selected load-balancing for the collective operation.

7. The method as recited in claim 1, wherein the switch is caused to use the selected network path specified by the metadata.

8. The method as recited in claim 1, wherein the switch is caused to use the selected load-balancing for the collective operation to route the unit of work over one or more specified paths.

9. The method as recited in claim 8, wherein the selected load-balancing comprises routing traffic with a path group in round robin mode over links of the path group.

10. A system comprising:
one or more processing devices; and
memory communicatively coupled with and readable by the one or more processing devices and having stored therein processor-readable instructions which, when executed by the one or more processing devices, cause the system to perform operations comprising:
determining metadata associated with a collective operation, wherein the metadata specifies at least one of:
a job identifier corresponding to a unit of work to be completed in conjunction with the collective operation;
a collective type of the collective operation; and/or
an ordering mode for packets corresponding to the collective operation;
sending the metadata associated with the collective operation to a network interface card (NIC) communicatively coupled to the system; and
causing the NIC to transmit a data packet with the metadata embedded in a cookie of the data packet to a switch of a network fabric to cause the switch to use a selected network path and/or selected load-balancing for the collective operation based at least in part on one or more of the job identifier, the collective type, and/or the ordering mode.

11. The system as recited in claim 10, wherein the ordering mode corresponds to an in-order mode, and the packets corresponding to the collective operation, including the data packet, are sent by the switch in-order on the same link in accordance with the metadata.

12. The system as recited in claim 10, wherein the ordering mode corresponds to an out-of-order mode, and the packets corresponding to the collective operation, including the data packet, are sent by the switch out-of-order across disparate links in accordance with the metadata.

13. The system as recited in claim 10, wherein the ordering mode corresponds to a selective out-of-order mode, and a first subset of the packets corresponding to the collective operation are sent in-order on the same link while a second subset of the packets are sent out-of-order across disparate links in accordance with the metadata.

14. The system as recited in claim 10, the operations further comprising sending the metadata associated with the collective operation to the switch.

15. The system as recited in claim 10, the operations further comprising sending, application via the NIC, a mapping of the metadata to particular actions to the switch, wherein the switch uses the mapping to interpret the metadata and perform one or more actions corresponding to the use of the selected network path and/or the selected load-balancing for the collective operation.

16. The system as recited in claim 10, wherein the switch is caused to use the selected network path specified by the metadata.

17. The system as recited in claim 10, wherein the switch is caused to use the selected load-balancing for the collective operation to route the unit of work over one or more specified paths.

18. The system as recited in claim 17, wherein the selected load-balancing comprises routing traffic with a path group in round robin mode over links of the path group.

19. One or more non-transitory, machine-readable media having machine-readable instructions thereon which, when executed by one or more processing devices, cause a system to perform operations comprising:
determining metadata associated with a collective operation, wherein the metadata specifies at least one of:
a job identifier corresponding to a unit of work to be completed in conjunction with the collective operation;
a collective type of the collective operation; and/or
an ordering mode for packets corresponding to the collective operation;
sending the metadata associated with the collective operation to a network interface card (NIC) communicatively coupled to the system; and
causing the NIC to transmit a data packet with the metadata embedded in a cookie of the data packet to a switch of a network fabric to cause the switch to use a selected network path and/or selected load-balancing for the collective operation based at least in part on one or more of the job identifier, the collective type, and/or the ordering mode.

20. The one or more non-transitory, machine-readable media as recited in claim 19, wherein the ordering mode corresponds to an in-order mode, and the packets corresponding to the collective operation, including the data packet, are sent by the switch in-order on the same link in accordance with the metadata.
